(19) United States
(12) Patent Application Publication
(10) Pub. No.: US 2004/0012700 A1
(43) Pub. Date: Jan. 22, 2004

(54) Image processing device, image processing program, and digital camera

(75) Inventors: Noriyuki Okisu, Osaka (JP); Ayumi Itoh, Nara-ken (JP); Tsutomu Honda, Osaka (JP)

Correspondence Address: Kenneth L. Cage, Esquire, McDERMOTT, WILL & EMERY, 600 13th Street, N.W., WASHINGTON, DC, 20005-3096, US

(73) Assignee: Minolta Co., Ltd.

(21) Appl. No.: 10/601,552

(22) Filed: Jun. 24, 2003

(30) Foreign Application Priority Data
Jun. 25, 2002 (JP) 2002-184571(PAT.)
Jul. 2, 2002 (JP) 2002-193362(PAT.)
Jul. 2, 2002 (JP) 2002-193363(PAT.)

(51) Int. Cl. H04N 5/222

(52) U.S. Cl. 348/333.01; 348/222.1

(57) ABSTRACT

An image processing device sets a processing value used for implementing an image processing with respect to a region of image data other than a region defined by an integral multiple of the size of a reference block if it is judged that the size of the image data in at least one of horizontal and vertical directions does not equal to the integral multiple of the size of a corresponding side of the reference block, and implements the image processing based on the processing value. With this arrangement, image processing is executable appropriately with respect to image data of an arbitrary size, and information such as characters written on a whiteboard or the like is reproducible clearly.

This application is based on Japanese patent application Nos. 2002-184571, 2002-193362, and 2002-193363 filed in Japan, the contents of which are hereby incorporated by reference.

### BACKGROUND OF THE INVENTION

1. Field of the Invention

This invention relates to an image processing device, and more particularly pertains to an image processing device capable of performing image processing with respect to an image of any size in such a manner that information such as characters is reproducible clearly by performing a predetermined processing.

2. Description of the Related Art

In recent years, digital cameras have been widespread rapidly because they have an advantage in obviating a developing process after photographing and facilitating alteration of a photographed image into various images by implementing an image processing. Digital cameras are not only utilized as an instrument for ordinary photographing but also as an instrument, for example, for recording information such as characters and figures written on whiteboards, panels or the like in conference halls, exhibition halls, or the like owing to their easiness in image processing. In the latter case, digital cameras are primarily used for the purpose of recording information on whiteboards or the like. Accordingly, it is essentially important for digital cameras used in the latter case to recognize an image portion corresponding to information.

In the case of a whiteboard, however, the surface of the whiteboard is likely to be illuminated from multiple directions with e.g. ceiling light or sunlight through a window. Therefore, it is highly likely that illumination distribution on the whiteboard surface becomes non-uniform due to non-uniform illumination light, which may likely to reproduce information on the whiteboard unclearly.

In view of the above, an inventor of the inventors of this application proposed a technique in Japanese Patent Application No. 9-13020 in which information such as characters written on a whiteboard is reproduced clearly by appropriately correcting illumination distribution non-uniformity even if an image to be reproduced is a color image photographed by a digital camera. This application is disclosed in Japanese Unexamined Patent Publication No. 10-210287 (corresponding to U.S. patent application Ser. No. 09/013,055, currently pending). According to this technique, an image is divided into a plurality of square blocks with each block having a size corresponding to a certain number of pixels, and a threshold value is determined with respect to each pixel by statistically calculating brightness level with respect to each block. In the case where the brightness level of a certain pixel exceeds the predetermined threshold value, the brightness level is replaced with a saturated level in white color (namely, the original brightness level is nullified). Thus, a gradation of an image portion on a whiteboard corresponding to the block where the brightness level of the pixel exceeds the threshold value is corrected to a saturated level in white color to reproduce information such as characters written on the whiteboard clearly. In order to implement the aforementioned image processing, the image size is limited such that the image has a size dividable into a number of square blocks with each block having a size corresponding to a certain number of pixels in view of feasibility in designing an application software and demand for production cost reduction.

There should be considered a variety of cases in reproducing an image on a whiteboard: an image which a user wishes to process may include an image in a periphery of a whiteboard where a background image such as a desk and a wall of a conference hall is displayed in a superposed manner; information which a user wishes to extract for image processing is part of an entire image; and an image which has been picked up by a digital camera has a size different from the size of the image which is inherently set in the digital camera for recording information on a whiteboard or the like. In any of the cases, it is less likely that the size of the image to be processed coincides with the image size optimally set for image processing. Therefore, if an image processing is implemented without executing a pre-processing in the above cases, it is highly likely that generated is a fraction (remainder) after dividing target image data based on a square block corresponding to a certain number of pixels. For instance, let it be assumed that image data corresponding to 1,550 pixels×1,140 pixels be divided by a square block with each side corresponding to 100 pixels. Whereas an image portion corresponding to 1,500 pixels×1,100 pixels is divided by 100 (corresponding to one side of the square block), the remainder cannot be divided by 100 with the result that the remainder is left unprocessed. Thus, the prior art fails to implement an appropriate image processing with respect to image data having such an odd size.

### SUMMARY OF THE INVENTION

In view of the above, it is an object of this invention to provide an image processing device that enables to reproduce information such as characters on a whiteboard or the like clearly by implementing an appropriate image processing with respect to image data having any size.

To accomplish the above object, according to an aspect of this invention, provided is an image processing device configured such that determined is a processing value used for implementing an image processing with respect to a region of image data other than a region defined by an integral multiple of the size of a reference block if it is judged that the size of the image data in at least one of horizontal and vertical directions does not equal to the integral multiple of the size of the corresponding side of the reference block, and image processing is implemented based on the determined processing value. With such a configuration, image processing is executable appropriately with respect to the image data having any size, thereby making it possible to reproduce information such as characters written on a whiteboard or the like clearly.

These and other objects, features and advantages of the present invention will become more apparent upon a reading of the following detailed description and accompanying drawing.

### BRIEF DESCRIPTION OF THE DRAWINGS

FIG. 1 is a perspective view showing an external appearance of a digital camera provided with an image processing device in accordance with a first embodiment of this invention;

FIG. 2 is a rear view of the digital camera provided with the image processing device in accordance with the first embodiment;

FIG. 3 is a block diagram showing a configuration of the digital camera provided with the image processing device in accordance with the first embodiment;

FIG. 4 is a flowchart showing a schematic operation of an image processing in the first embodiment;

FIGS. 5A through 5E are illustrations showing examples as to how image data is divided into first-zone image data and second-zone image data;

FIG. 6 is a flowchart (part 1) of the digital camera provided with the image processing device in accordance with the first embodiment;

FIG. 7 is a flowchart (part 2) of the digital camera provided with the image processing device in accordance with the first embodiment;

FIG. 8 is a flowchart (part 3) of the digital camera provided with the image processing device in accordance with the first embodiment;

FIG. 9 is a flowchart (part 4) of the digital camera provided with the image processing device in accordance with the first embodiment;

FIG. 10 is an illustration showing image data to be used in fine adjustment of white balance;

FIG. 11 is an illustration showing a central part of image data which is divided based on a square block;

FIG. 12 is an illustration explaining how image data is divided based on an area;

FIG. 13 is an illustration showing an example of a histogram concerning brightness data (Y data) in an area in terms of 64 gradations;

FIG. 14 is an illustration explaining how image data is divided based on a square block;

FIG. 15 is an illustration showing an example of a histogram concerning brightness data (Y data) in a square block in terms of 64 gradations;

FIG. 16 is an illustration showing a corner portion of image data to explain a relationship between a ground level in a square block and a ground level in a fractional block;

FIG. 17 is an illustration explaining an approach for calculating a ground level of a pixel based on ground levels in four square blocks in accordance with linear interpolation;

FIG. 18 is an illustration showing a relationship between a ground level of a pixel calculated by linear interpolation and a cell;

FIGS. 19A and 19B are an illustration explaining a approach for determining a ground level of a pixel in a peripheral portion of image data;

FIG. 20 is an illustration showing an example of a filter used in edge emphasizing processing;

FIG. 21 is an illustration showing an example of a correction characteristic used in ground skipping/gradation correction;

FIG. 22 is an illustration showing an example of a correction characteristic used in black level emphasizing processing;

FIG. 23 is an illustration showing an example of a histogram concerning brightness data (Y data) of image data in terms of 64 gradations;

FIG. 24 is an illustration showing an example of a correction characteristic used in gradation expanding processing;

FIG. 25 is a block diagram showing a configuration of a digital camera provided with an image processing device in accordance with a second embodiment of this invention;

FIG. 26 is a flowchart showing a schematic operation of an image processing in the second embodiment;

FIG. 27 is a flowchart (part 1) of the digital camera provided with the image processing device in accordance with the second embodiment;

FIG. 28 is a flowchart (part 2) of the digital camera provided with the image processing device in accordance with the second embodiment;

FIG. 29 is a flowchart (part 3) of the digital camera provided with the image processing device in accordance with the second embodiment;

FIG. 30 is a flowchart (part 4) of the digital camera provided with the image processing device in accordance with the second embodiment;

FIG. 31 is a block diagram showing a configuration of a digital camera provided with an image processing device in accordance with a third embodiment of this invention;

FIG. 32 is a flowchart showing a schematic operation of an image processing in the third embodiment;

FIG. 33 is a flowchart (part 1) of the digital camera provided with the image processing device in accordance with the third embodiment;

FIG. 34 is a flowchart (part 2) of the digital camera provided with the image processing device in accordance with the third embodiment;

FIG. 35 is a flowchart (part 3) of the digital camera provided with the image processing device in accordance with the third embodiment;

FIG. 36 is a flowchart (part 4) of the digital camera provided with the image processing device in accordance with the third embodiment;

FIG. 37 is an illustration explaining a fractional block; and

FIGS. 38A and 38B are illustrations showing a correspondence between a ground level in each block of image data after size varying processing and a ground level in each block of original image data.

### DESCRIPTION OF THE PREFERRED EMBODIMENTS

Hereinafter, preferred embodiments of this invention are described with reference to the accompanying drawings. Elements in the respective drawings which are identical to each other are denoted by the same reference numerals, and repeated description thereof is omitted herein.

(First Embodiment)

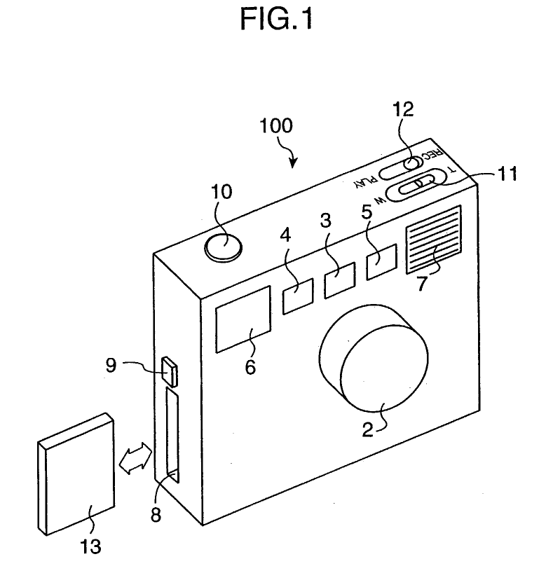

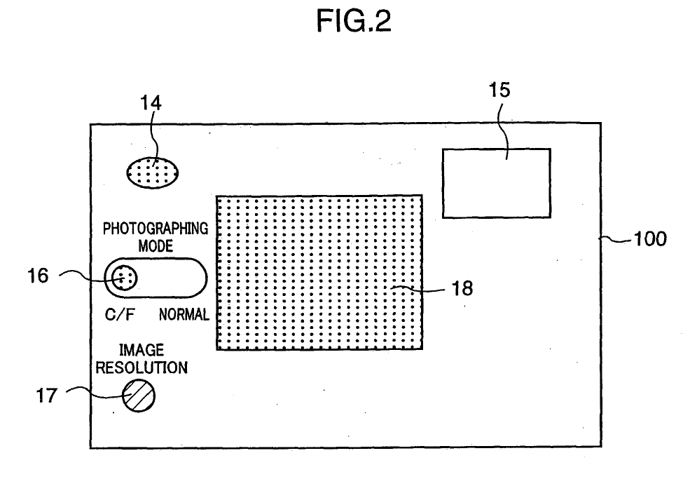

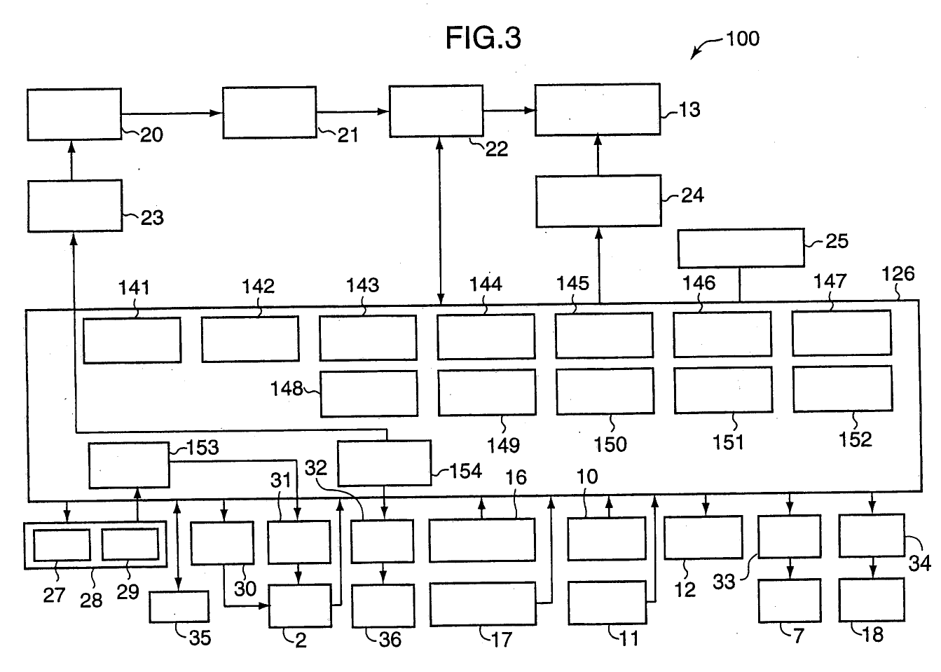

FIG. 1 is a perspective view showing an external appearance of a digital camera provided with an image processing device in accordance with a first embodiment of this invention. FIG. 2 is a rear view of the digital camera provided with the image processing device in accordance with the first embodiment. FIG. 3 is a block diagram showing an arrangement of the digital camera provided with the image processing device in accordance with the first embodiment.

Referring to FIG. 1, an external appearance of the digital camera is described. The digital camera 100 is comprised of a taking lens 2 disposed substantially in the middle of the front face thereof. A light projecting window 4 and a light receiving window 5 are formed above the taking lens 2 to meter a distance to an object in accordance with an active metering method. A light metering window 3 is formed between the light projecting window 4 and the light receiving window 5 to meter brightness of an object. A viewfinder objective window 6 is formed in the left of the light projecting window 4, and a flashlight section 7 is arranged on the right of the light receiving window 5.

The taking lens 2 includes various lenses such as a zoom lens and a focus lens. The taking lens 2 is an image sensing optical system for guiding light from an object with an appropriate light amount and focal point onto an image sensing section 20 which will be described later. The light projecting window 4 is a window through which an infrared ray is irradiated onto an object. The light receiving window 5 is a window through which reflected light of the infrared ray from the object is received. In this embodiment, an active metering method is adopted as a metering method. Alternatively, a passive metering method may be applicable. The flashlight section 7 is a flash for emitting flashlight to illuminate an object as timed with an image sensing operation in the case where the light amount from an object is insufficient.

The digital camera 100 is formed with a card insertion slot 8 in a side face thereof to detachably attach a memory card 13 for storing image data. A card eject button 9 is provided above the card insertion slot 8 to eject the memory card 13. With this arrangement, in printing a result of photographing, a user is allowed to print out the photographing result by pushing the card eject button 9 to eject the memory card 13 from the digital camera 100 and by loading the memory card 13 into a printer loadable with the memory card 13. Alternatively, a user is allowed to print out the photographing result by loading the memory card 13 into a personal computer (hereinafter, simply called as “PC”) connected to a printer and loadable with the memory card 13. Further alternatively, a user is allowed to store image data generated in other digital camera or a scanner in the memory card 13 by loading the memory card 13 into a PC loadable with the memory card 13.

As an altered form, it may be possible to directly transmit image data from the digital camera 100 to a printer or a PC for printing a photographed image by attaching a Universal Serial Bus (USB) interface to the digital camera 100 and by connecting the digital camera 100 with the printer or the PC via a USB cable.

In this embodiment, adopted as an image data recording medium is a memory card in compliance with Personal Computer Memory Card International Association (PCMCIA). Alternatively, as far as it is a storage medium capable of recording photographing results as image data, any other recording medium such as hard disc card, Mini-Disk (MD), and Compact Disc Recordable (CD-R) may be applicable.

A shutter button 10 is arranged on a left end portion on the upper face of the digital camera 100. A zoom switch 11 and a photographing/reproducing switch 12 are arranged on a right end portion on the upper face of the digital camera 100. The shutter button 10 is connected with a controller 126, which will be described later. The shutter button 10 is an operation button. Specifically, when the shutter button 10 is depressed halfway, a switch SW1 indicative of designating photographing preparatory operation such as focus distance adjustment and exposure control value setting is turned on. When the shutter button 10 is depressed fully, a switch SW2 indicative of designating shutter release is turned on. The zoom switch 11 is connected with the controller 126. The zoom switch 11 is a three-contact switch slidable in sideways directions. Zooming ratio of the taking lens 2 can be continuously varied such that it is changed to a telescopic side by sliding the zoom switch 11 in T (TELL) direction and is changed to a wide-angle side by sliding the zoom switch 11 in W (WIDE) direction.

The photographing/reproducing switch 12 is a switch which is connected with the controller 126 and is operative to change over the camera between photographing mode and reproducing mode. The photographing/reproducing switch 12 is a two-contact switch slidable in sideways directions. When the photographing/reproducing switch 12 is set to photographing (REC) side, an image sensed by the image sensing section 20 is displayed on a liquid crystal display (LCD) section 18, and at the same time, the digital camera 100 is ready for photographing an object. On the other hand, when the photographing/reproducing switch 12 is set to reproducing (PLAY) side, image data recorded on the memory card 13 is displayable on the LCD section 18 (see FIG. 2). Manipulating an unillustrated switch while setting the photographing/reproducing switch 12 to reproducing side allows a user to designate start of an image processing with respect to the image displayed on the LCD section 18, which will be described later.

Referring to FIG. 2, a main switch 14 for power supply is arranged on an upper left end portion on the rear face of the digital camera 100. The LCD section 18 is provided substantially in the middle of the rear face of the digital camera 100. A viewfinder eyepiece window 15 is formed in an upper right end portion on the rear face of the digital camera 100. A photographing mode setting switch 16 and an image resolution selecting switch 17 are arranged below the main switch 14.

The photographing mode setting switch 16 is a switch connected with the controller 126 for selecting photographing mode. For instance, the photographing mode setting switch 16 is comprised of an ON/OFF switch which is turned on and off in response to sliding operation in sideways directions. While the photographing mode setting switch 16 is slid in rightward direction in FIG. 2, namely, slid to OFF (open) side, the camera 100 is in normal photographing mode (indicated as “NORMAL” in FIG. 2). On the other hand, while the photographing mode setting switch 16 is slid in leftward direction in FIG. 2, namely, slid to ON (close) side, the camera 100 is in character/figure photographing mode (indicated as “C/F” in FIG. 2).

The image resolution selecting switch 17 is connected with the controller 126 and operative to select resolution of a sensed image. The image resolution selecting switch 17 is, for example, comprised of a pressing button. Specifically, each time the switch 17 is depressed, the image size is changed, and information relating to the image size after the size change is displayed on the LCD section 18. For instance, each time the image resolution selecting switch 17 is depressed, the LCD section 18 cyclically displays super-fine mode having resolution of 2,560 pixels×1,920 pixels, fine mode having resolution of 1,960 pixels×1,440 pixels, standard mode having resolution of 1,280 pixels×960 pixels, and energy-saving mode having resolution of 640 pixels×480 pixels, and then returns the indication to super-fine mode.

The LCD section 18 is adapted not only to display photographed images but also to display a status relating to photography setting of the digital camera 100 such as display as to whether the camera is in photographing mode or reproducing mode, and whether the camera is in normal photographing mode or character/figure photographing mode. The LCD section 18 may be a display device composed of e.g. an organo-electro-luminescence in place of a liquid crystal.

Referring to FIG. 3, the configuration of the digital camera 100 is described. As shown in FIG. 3, the digital camera 100 basically includes the image sensing section 20, an analog-to-digital converting section (hereinafter, simply called as “A/D converting section”) 21, an image memory 22, the memory card 13, an image sensing driving section 23, a card controlling section 24, a storage section 25, the controller 126, a distance metering section 28, a zoom driving section 30, a lens driving section 31, an aperture driving section 32, the photographing mode setting switch 16, the shutter button 10, the photographing/reproducing switch 12, a light emitting controlling section 33, an LCD driving section 34, a light metering section 35, the taking lens 2, an aperture 36, the image resolution setting switch 17, the zoom switch 11, the flashlight section 7, and the LCD section 18.

The controller 126 includes an image size judging section 141, a zone dividing section 142, a block ground level determining section 143, a fractional block ground level allocating section 144, a pixel ground level determining section 145, a ground skipping/gradation correcting section 146, an LH/LH calculating section 147, a white balance (hereinafter, simply called as “WB”) fine adjustment section 48, an RGB/YCrCb converting section 149, an edge emphasizing section 150, a black level emphasizing section 151, a gradation expanding/correcting section 152, an AF control value calculating section 153, and an exposure control value calculating section 154. In this embodiment, the image memory 22, the card controlling section 24, the storage section 25, and the controller 126 constitute an image processing device.

The image sensing driving section 23 controls a sensing operation of the image sensing section 20 based on a shutter speed corresponding to an exposure control value outputted from the controller 126. The image sensing section 20 has a number of pixels incorporated with a number of photoelectric conversion elements. The image sensing section 20 photoelectrically converts a light image of an object into image signals of respective color components of R, G, B by performing an image sensing operation (charge accumulating operation) based on a control signal from the image sensing driving section 23, and converts the image signals to time-series signals to output the time-series signals to the A/D converting section 21. The image sensing section 20 is comprised of e.g. solid-state image sensing elements such as Charge-Coupled Devices (CCDs) of a color area sensor.

The A/D converting section 21 converts an analog image signal generated in the image sensing section 20 to a digital image signal (image data) of e.g. 8-bit, and outputs the digital image data to the image memory 22. The image memory 22 is a memory which is connected with the controller 126 and stores the digital image data temporarily therein for image processing. After implementing the image processing which will be described later, the image memory 22 outputs the processed image data to the memory card 13. The image memory 22 includes e.g. a Random Access Memory (RAM), and has a sufficient storage capacity for implementing integral image processing.

The card controlling section 24 controls driving of the memory card 13 based on a control signal from the controller 126 so as to record the image data. The storage section 25 is a memory which is connected with the controller 126 and stores a variety of programs necessary for operating the digital camera 100, and various data such as data to be processed while a program is running. The storage section 25 is comprised of e.g. an RAM and a Read Only Memory (ROM).

The distance metering section 28 includes a light projecting section 27 which is disposed behind the light projecting window 4 and emits an infrared ray, and a light receiving section 29 which is disposed behind the light receiving window 5 and receives the infrared ray reflected from an object. The distance metering section 28 detects a distance to the object based on a control signal from the controller 126, and outputs a detection result to the controller 126. The light metering section 35 is comprised of a light receiving element such as a Position Sensitive Detector (PSD) disposed behind the light metering window 3. The light metering section 35 meters brightness of the object based on a control signal from the controller 126, and outputs a metering result to the controller 126.

The zoom driving section 30 controls zooming operation of the taking lens 2 based on a drive signal from the controller 126. The lens driving section 31 controls focusing operation of the taking lens 2 based on an AF control value outputted from the controller 126. The aperture driving section 32 controls an opening amount of the aperture 36 based on an aperture value Av corresponding to an exposure control value outputted from the controller 126. The LCD driving section 34 drives the LCD section 18 to display image data processed in the image memory 22 and photography setting status of the digital camera 100 based on a control signal from the controller 126. The light emitting controlling section 33 controls the flashlight section 7 to emit flashlight based on a control signal from the controller 126.

The controller 126 is comprised of a microprocessor. As will be describe later, the controller 126 centrally controls various operations such as photographing and image processing operations of the digital camera 100 by the elements 141 through 154. The image size judging section 141 detects the size of image data generated by sensing an object image, and judges whether the detected size is a size executable of image processing, a size executable of ground skipping/gradation correction, a size executable of WB fine adjustment, and a size executable of zone dividing. The zone-dividing section 142 divides the image data outputted from the image memory 22 into image data in a first zone (first-zone image data) and image data in a second zone (second-zone image data), and extracts the first-zone image data from the image data. The block ground level determining section 143 calculates a ground level in an area of the first-zone image data in accordance with a statistical processing, and then calculates a ground level in a block (reference block) of the first-zone image data. Throughout the specification and claims of this invention, a brightness level of a ground portion corresponding to a white portion of a sensed image other than character/figure image data is referred to as “ground level”. The fractional block ground level allocating section 144 allocates a ground level to a fractional block of the second-zone image data based on the ground level in a boundary block of the first-zone image data adjacent to the fractional block. The pixel ground level determining section 145 calculates a ground level of a pixel based on the reference block ground level and the fractional block ground level respectively determined by the block ground level determining section 143 and the fractional block ground level allocating section 144. The ground skipping/gradation correcting section 146 converts brightness level of a pixel in accordance with a characteristic curve based on the ground level of the pixel so as to suppress illumination distribution non-uniformity and to reproduce a ground portion of the image clearly. The LH/LS calculating section 147 calculates highlight level LH and shadow level LS of image data in accordance with a statistical processing. The WB fine adjustment section 148 adjusts WB of image data based on a predetermined mathematical expression. The RGB/YCrCb converting section 149 converts RGB data into Y data, Cr data, and Cb data, and then converts Y data, Cr data, and Cb data into RGB data based on a predetermined mathematical expression. The edge emphasizing section 150 emphasizes an edge of an image with use of a filter. The black level emphasizing section 151 adjusts brightness level of a pixel based on a predetermined characteristic curve to reproduce information such as characters clearly. The gradation expanding/correcting section 152 correctively expands gradation of image data in accordance with a characteristic curve based on highlight level LH and shadow level LS of image data. The AF control value calculating section 153 calculates a driving amount of the focus lens of the taking lens 2 so as to focus light from an object onto the image sensing elements of the image sensing section 20 based on an output from the distance metering section 28. The exposure value calculating section 154 calculates aperture value Av and exposure time Tv in accordance with a programmed control based on an output from the light metering section 35.

(Operation of First Embodiment)

Now, operation of the digital camera provided with the image processing device in accordance with the first embodiment is described roughly and then in detail. First, operation of the digital camera in the first embodiment is described roughly.

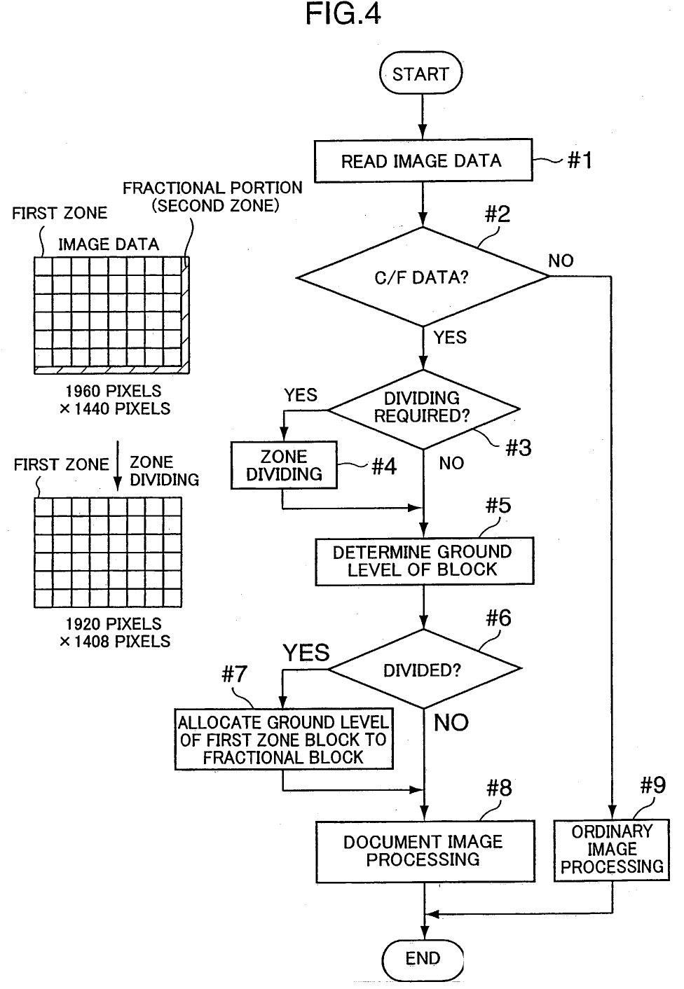

FIG. 4 is a flowchart showing a schematic operation of image processing in the first embodiment.

Referring to FIG. 4, image data for image processing is read (Step #1). Image data may be, for instance, image data that has been obtained by sensing an object image with the digital camera on the spot, or image data that has been obtained by sensing an object image with the digital camera in advance and stored in the memory card 13, or image data that has been obtained by reading an object image photographed by a still camera with an image reader such as a scanner and stored in the memory card 13.

Next, the controller 126 judges whether the size of the image data and the image data itself meet the requirements concerning document image processing. If it is judged that the image data is character/figure image data or the like that have been obtained by sensing information such as characters written on a whiteboard or the like (YES in Step #2), the controller 126 proceeds to Step #3. On the other hand, if it is judged that the image data is other than character/figure image data (NO in Step #2), the controller 126 proceeds to Step #9.

In Step #3, the controller 126 judges whether it is necessary to divide the image data into first-zone image data and second-zone image data. If it is judged that the image data does not have a size corresponding to an integral multiple of the size of a reference block (YES in Step #3), the controller 126 proceeds to Step #4 and then to Step #5. On the other hand, if it is judged that the image data has a size corresponding to an integral multiple of the size of the reference block, the controller 126 proceeds to Step #5. For instance, in the case where the image data has a size corresponding to 1,960 pixels×1,440 pixels, and the reference block is a square block corresponding to 128 pixels×128 pixels, there is generated a fractional portion corresponding to 40 pixels in horizontal direction and 32 pixels in vertical direction. In such a case, the image data has to be divided into first-zone image data and second-zone image data.

In Step #4, the controller 126 divides the entire image data into first-zone image data and second-zone image data, and extracts the first-zone image data from the entire image data. The first-zone image data is part of the entire image data for image processing, and one side thereof in horizontal direction has a number of pixels equal to an integral multiple of the number of pixels of a side of a reference block in horizontal direction and the other-side thereof in vertical direction has a number of pixels equal to an integral multiple of the number of pixels of a side of the reference block in vertical direction. The second-zone image data is a remainder of the entire image data obtained by extracting the first-zone image data from the entire image data.

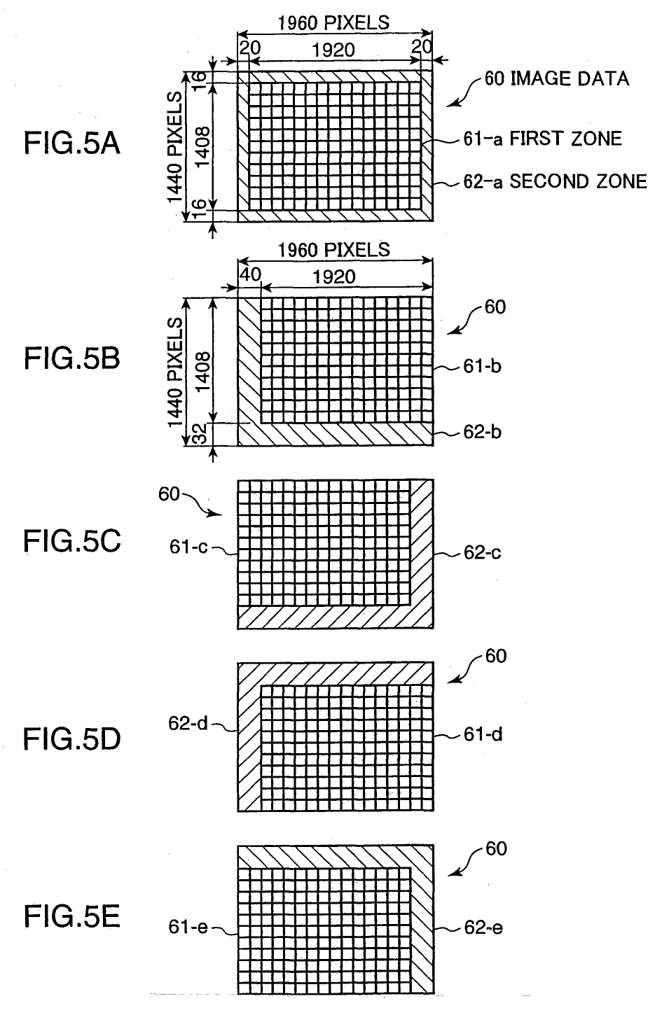

For instance, as shown in FIGS. 5A through 5E, image data 60 corresponding to 1,960 pixels×1,440 pixels consists of first-zone image data 61 (61-a to 61-e) and second-zone image data 62 (62-a to 62-e) corresponding to the remainder of the image data 60 obtained by extracting the first-zone image data 61 from the entire image data 60. The second-zone image data 62 has different shapes depending on where the first-zone image data 61 is arranged within the entire image data 60.

Specifically, when the first-zone image data 61-a occupies a central part of the image data 60, the second-zone image data 62-a occupies a peripheral part of the image data 60, as shown in FIG. 5A. The second-zone image data 62-a consists of a number of fractional blocks arrayed in a row (horizontal direction) in which each fractional block has a size corresponding to 128 pixels in horizontal direction and 16 pixels in vertical direction, a number of fractional blocks arrayed in a column (vertical direction) in which each fractional block has a size corresponding to 20 pixels in horizontal direction and 128 pixels in vertical direction, and four corner fractional blocks each having a size corresponding to 20 pixels in horizontal direction and 16 pixels in vertical direction.

When the first-zone image data 61-b occupies an upper right portion of the image data 60, as shown in FIG. 5B, the second-zone image data 62-b occupies an L-shape portion of the image data 60 extending upward and rightward directions. When the first-zone image data 61-c occupies an upper left portion of the image data 60, as shown in FIG. 5C, the second-zone image data 62-c occupies a horizontally mirror-symmetrical L-shape portion extending upward and leftward directions. When the first-zone image data 61-d occupies a lower right portion of the image data 60, as shown in FIG. 5D, the second-zone image data 62-d occupies a vertically mirror-symmetrical L-shape portion extending downward and rightward directions. When the first-zone image data 61-e occupies a lower left portion of the image data 60, as shown in FIG. 5E, the second-zone image data 62-e occupies an inverted L-shape portion extending downward and leftward directions.

In FIGS. 5B (or 5C, 5D, 5E), the second-zone image data 62-b (or 62-c, 62-d, 62-e) consists of a number of fractional blocks arrayed in a row (horizontal direction) in which each fractional block has a size corresponding to 128 pixels×32 pixels, a number of fractional blocks arrayed in a column (vertical direction) in which each fractional block has a size corresponding to 40 pixels×128 pixels, and one corner fractional block having a size corresponding to 40 pixels×32 pixels. In this way, the arrangement of the fractional blocks differs depending on where the first-zone image data 61 is arranged within the image data 60. In any case, the fractional block is a rectangular block which is defined by vertical and horizontal grid lines defining a reference square block in the first-zone image data 61. It should be appreciated that in FIGS. 5A through 5E, the size of the reference block in the first-zone image data 61 and the size of the fractional block in the second-zone image data 62 are displayed with scales different from each other for sake of convenience for illustration.

Referring back to FIG. 4, in Step #5, the controller 126 performs pre-processing prior to ground skipping/gradation correction processing. Specifically, if the image data 60 has a size (number of pixels) equal to an integral multiple of the number of pixels corresponding to a corresponding side of a reference block, the controller 126 determines the ground level of the block with respect to the image data 60 as a preprocessing value block by block. On the other hand, if the image data 60 does not have a size (number of pixels) equal to an integral multiple of the number of pixels corresponding to the corresponding side of the reference block, the controller 126 determines the ground level of the block with respect to the first-zone image data 61 as a preprocessing value block by block.

Next, the controller 126 judges whether zone-dividing processing has been carried out (Step #6). If it is judged that zone-dividing processing has been carried out (YES in Step #6), the controller 126 allocates a ground level, as the preprocessing value, to each fractional block of the second-zone image data 62 based on the ground level in the reference block of the first-zone image data 61 (Step #7), and then proceeds to Step #8. On the other hand, if it is judged that zone-dividing processing has not been carried out (NO in Step #6), the controller 126 proceeds to Step #8 while skipping Step #7.

In Step #8, if it is judged that brightness level of each pixel exceeds a predetermined threshold value, the controller 126 carries out a series of document image processing such as ground skipping/gradation correction processing for converting a brightness level exceeding the predetermined threshold value to a possible maximal brightness level, edge emphasizing processing with use of a filter, and black level highlight processing for converting a brightness level not exceeding the predetermined threshold value to a black level so as to reproduce character information clearly. In this embodiment, the threshold value in ground skipping/gradation correction processing is set pixel by pixel after calculating the ground level of each block. The threshold value, namely, the ground level of each pixel can be appropriately set because the ground level of each block can be determined by implementing zone-dividing and allocating processing even if original image data does not have a number of pixels equal to an integral multiple of the number of pixels corresponding to a corresponding side of a reference block.

On the other hand, if the judgment result in Step #2 is negative, the controller 126 implements normal image processing such as gradation expanding correction with respect to image data other than character/figure image data, and terminates the control (Step #9).

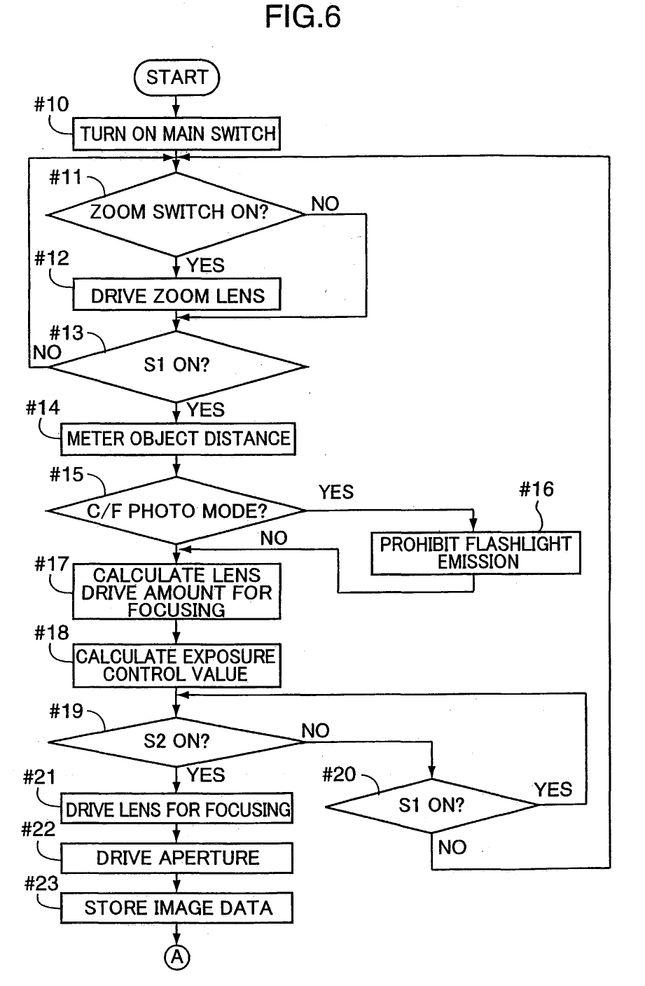

Next, the operation of the digital camera provided with the image processing device in accordance with the first embodiment is described in detail. FIGS. 6 through 9 are a set of flowcharts showing the operation of the digital camera provided with the image processing device in accordance with the first embodiment.

(Image Sensing Operation)

In FIGS. 6 through 9, when a user slides the photographing/reproducing switch 12 to photographing (REC) side in photographing operation, and turns the main switch 14 on, the digital camera 100 is started up, and the controller 126 reads the program stored in the storage section 25 to initialize the respective parts of the digital camera 100. Thus, the digital camera 100 is rendered to a photographable state. At this time, when the user depresses the image resolution selecting switch 17 while referring to the display regarding the image resolution on the LCD section 18, a desired image resolution is set (Step #10). In this state, the controller 126 judges whether the zoom switch 11 has been operated or not (Step #11).

If it is judged that the zoom switch 11 has been operated (YES in Step #11), the controller 126 controls the zoom driving section 30 to drive the zoom lens of the taking lens 2 in accordance with the operated direction and the operated amount to thereby change the zooming ratio (Step #12). Thereafter, the controller 126 proceeds to Step #13. On the other hand, if it is judged that the zoom switch 11 has not been operated (NO in Step. #11), the controller 126 proceeds to Step #13 while skipping Step #12. In this case, the zoom lens of the taking lens 2 is not driven.

In Step #13, the controller 126 judges whether the shutter button 10 is depressed halfway and the switch S1 is turned on. If it is judged that the switch S1 is in an OFF state (NO in Step #13), the control in the controller 126 is returned to Step #11. On the other hand, if it is judged that the switch S1 is in an ON state (YES in Step #13), the controller 126 proceeds to Step #14 to implement photographing preparatory operation.

Specifically, in Step #14, the controller 126 allows the light projecting section 27 in the distance metering section 28 to project infrared ray toward an object to meter the distance to the object. The controller 126 reads data concerning the distance metering by allowing the light receiving section 29 in the distance metering section 28 to receive light reflected from the object obtained by projection of the infrared ray, and calculates the distance to the object.

Next, the controller 126 judges photographing mode based on a judgment whether the photographing mode setting switch 16 is set to character/figure (C/F) photographing mode or normal photographing mode (Step #15). If it is judged that the photographing mode setting switch 16 is set to character/figure (C/F) photographing mode (YES in Step #15), the controller 126 outputs a control signal indicative of prohibiting flashlight emission to the flashlight controlling section 33 to thereby prohibit the flashlight section 7 from emitting flashlight (Step #16), and then proceeds to Step #17. On the other hand, if it is judged that the photographing mode setting switch 16 is set to normal photographing mode (NO in Step #15), the controller 126 proceeds to Step #17. The flashlight section 7 is prohibited from emitting flashlight if it is judged that the switch 16 is in character/figure photographing mode because there is a likelihood that flashlight from the flashlight section 7 may be subjected to total reflection on a whiteboard in case that the flashlight section 7 automatically emits flashlight at a scene of photographing information on a whiteboard right from the front, which may render character information of the sensed image illegible.

In Step #17, the controller 126 calculates a lens driving amount used for setting the focus lens of the taking lens 2 to a focal point based on the detected object distance with use of the AF control value calculating section 153 (Step #17), and calculates an exposure control value based on data concerning light metering detected by the light metering section 35 with use of the exposure control value calculating section 154 (Step #18). By performing the aforementioned operations, the photographing preparatory operation is completed, and the digital camera 100 is brought to a shutter release stand-by state.

When the digital camera 10 is brought to a shutter release stand-by state, the controller 126 judges whether the shutter button 10 is fully depressed, and the switch S2 is turned on (Step #19). If it is judged that the shutter button 10 is fully depressed, and the switch S2 is in an ON state (YES in Step #19), the controller 126 implements shutter release operation. On the other hand, if it is judged that the shutter button 10 is not fully depressed, the controller 126 judges whether the shutter button 10 is halfway depressed, and the switch S1 is in an ON state (Step #20). If it is judged that the shutter button 10 is kept on being depressed halfway, and the switch S1 is in an ON state (YES in Step #20), the control in the controller 126 is returned to Step #19 to keep the shutter release stand-by state of the camera 100. On the other hand, if it is judged that the shutter button 10 is kept on being depressed halfway, and the switch S1 is in an OFF state, the control in the controller 126 is returned to Step #11.

When the camera 100 is proceeded to the shutter release operation, the controller 126 outputs data concerning the lens driving amount to the lens driving section 31 for focusing operation of the taking lens 2 (Step #21), and outputs data concerning the aperture value Av corresponding to the exposure control value to the aperture driving section 32 to adjust the opening amount of the aperture 36 (Step #22). The controller 126 allows the image sensing elements of the image sensing section 20 to be exposed to light in correspondence to the exposure time obtained in Step #18 so as to sense an object image by charge accumulation, implements a known ordinary processing with respect to signals inputted to the image sensing elements, and stores image data of a size which has been predefined by the image resolution selecting switch 17 into the image memory 22 via the A/D converting section 21 (Step #23).

(Image Processing Operation)

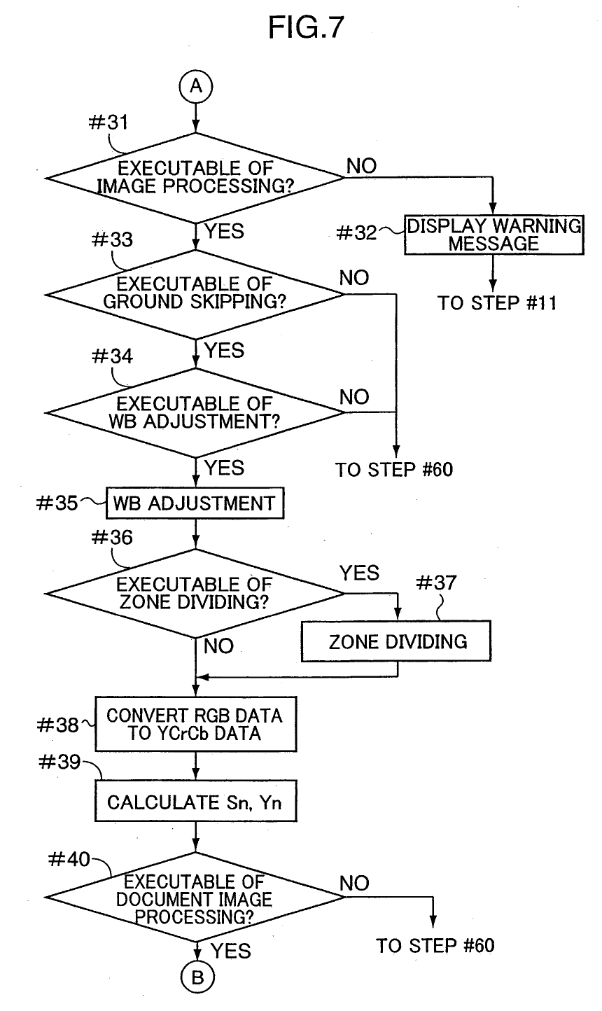

Next, referring to FIG. 7, the controller 126 judges whether the stored image data is of a size executable of image processing by counting the number of pixels corresponding to each side of the image data with use of the image size judging section 141 (Step #31). The reason for judging whether image data is of a size executable of image processing is that image data is to be statistically processed, which will be described later, irrespective of a condition that image data is processed as character image data (namely, ground skipping/gradation correction is carried out) or a condition that image data is processed as photographic image data (namely, gradation expansion is carried out). A certain number of data to satisfy statistical precision is required in order to acquire a sufficient precision since data is handled from a statistical viewpoint. In view of this, if it is judged that the number of pixels corresponding to image data is less than a predetermined value, e.g., the number of pixels corresponding to the image data is less than 480 pixels×480 pixels (NO in Step #31), the controller 126 causes the LCD section 18 to display a warning message indicating that character image processing is not executable (Step #32), and the control in the controller 126 is returned to Step #11.

On the other hand, if it is judged that the number of pixels corresponding to image data is not smaller than the predetermined value (YES in Step #31), the controller 126 judges whether the image data is of a size executable of ground skipping/gradation correction with use of the image size judging section 141 (Step #33). Ground skipping/gradation correction processing is, as will be described later, such that image data is divided into a plurality of blocks, and image processing is implemented block by block, wherein processing is implemented with respect to a certain block by considering information in the vicinity of the certain block. In view of this, a certain number of blocks both in horizontal and vertical directions is required to implement ground skipping/gradation correction processing with sufficient precision. Therefore, if it is judged that the number of pixels corresponding to the image data is less than the predetermined value, for instance, the number of pixels corresponding to the shorter side of the image data is less than 640 (NO in Step #33), the controller 126 proceeds to Step #60 to implement photographic image processing.

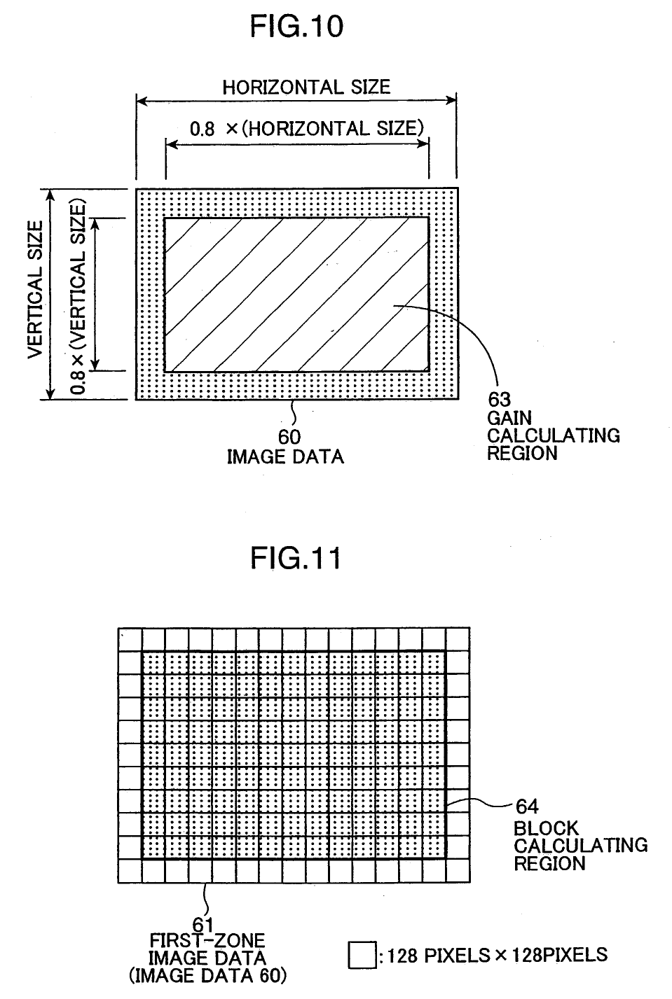

On the other hand, if it is judged that the number of pixels corresponding to the image data is not smaller than the predetermined value, the controller 126 judges whether the image data is of a size executable of WB fine adjustment with use of the image size judging section 141 (Step #34). WB fine adjustment is, as shown in FIG. 10, carried out with use of the number of pixels corresponding to a central part of the image data 60 (gain calculating region 63 shown by the hatched portion in FIG. 10) having a size both in horizontal and vertical directions of about 80% relative to the image data 60 in the corresponding direction. Accordingly, if the number of pixels corresponding to the gain calculating region 63 in one direction is less than several percent relative to the total number of pixels corresponding to the image data 60 in the corresponding direction, e.g., less than 5%, the number of pixels to be used for image processing is too small compared with the total number of pixels corresponding to the image data 60. In such a case, it is not appropriate to perform WB fine adjustment with respect to such small-size image data as the gain calculating region 63. In view of this, in this embodiment, the controller 126 goes to Step #60 to implement photographic image processing if it is judged that the number of pixels corresponding to the gain calculating region 63 is less than a predetermined number of pixels, which is a possible minimal number sufficient to implement WB fine adjustment (NO in Step #34).

The central part of the image data 60 corresponding to about 80% of the image data 60 is defined as the gain calculating region 63 for WB fine adjustment for the following reason. Since it is conceived that a background image is likely to be sensed in a peripheral part of a target image in sensing the target image, it is preferable to set a central part of the image data 60 corresponding to about 80% of the entire image data 60 as a region for WB fine adjustment to securely sense information such as characters. For this reason, in this embodiment, a central part corresponding to about 80% of the entire image data is set as a region for WB fine adjustment. Alternatively, a desired percentage other than 80% may be applicable as long as information such as characters on a whiteboard can be securely sensed.

On the other hand, if it is judged that the generated image data has a number of pixels not smaller than the predetermined number of pixels sufficient for WB fine adjustment (YES in Step #34), the controller 126 implements WB fine adjustment with use of the WB fine adjustment section 148 (Step #35). Specifically, in WB fine adjustment, the controller 126 judges whether the gain calculating region 63 (corresponding to 80%. of the image data 60 in horizontal and vertical directions) has a number of pixels in horizontal and vertical directions that meet the following mathematical expressions 1 and 2, and extracts a number of pixels that meet the mathematical expressions 1 and 2:

(R−G)²+(B−G)²<ThSwb Ex. 1

0.3R+0.6G+0.1B>ThYwb Ex. 2

R, G, and B respectively denote data of red, green, and blue components of a pixel. Since the expression 1 is a formula for removing pixels of chromatic color to appropriately adjust WB, the right term ThSwb in the expression 1 is empirically determined as a parameter for discriminating whether the pixel is achromatic color or chromatic color. For instance, in this embodiment, ThSwb=900. Since the expression 2 is a formula for removing pixels having low brightness to appropriately adjust WB, the right term ThYwb in the expression 2 is empirically determined as a parameter for discriminating whether brightness of the pixel is high or low. For instance, in this embodiment, ThYwb=190. The controller 126 calculates the sums of respective data of R, G, and B with respect to the extracted pixels and calculates a gain value Gain_R and a gain value Gain_B as a multiplier by which the respective data of R, B are to be multiplied based on the sum of G data. Further, the controller 126 multiplies the data of R and B by the gain value Gain_R and the gain value Gain_B which have been calculated with respect to all the pixels of the entire image data 60, respectively. In this way, WB fine adjustment is carried out.

Next, the controller 126 judges whether the image data 60 has a fractional block or blocks if the image data 60 is divided into a number of reference blocks with use of the image size judging section 141 by e.g. dividing the number of pixels on each side of the image data 60 by the number of pixels corresponding to the corresponding side of a square block (Step #36). By implementing this operation, it is judged whether it is necessary to implement zone-dividing processing with respect to the image data 60 in which the image data 60 is divided into first-zone image data 61 and second-zone image data 62, and the first-zone image data 61 is separated (extracted). In this embodiment, a reference block is a square block in the aspect of feasibility in matching computation of the number of blocks in horizontal and vertical directions of image data with each other, which will be described later. Alternatively, this invention is applicable to a case where a reference block is a rectangular block having a shorter side and a longer side. Setting a square block as a reference block, however, is advantageous in eliminating a likelihood that directionality may affect results of computation concerning the number of blocks in horizontal and vertical directions of image data if an image within the block(s) has directionality. The size of a square block is empirically determined by appropriately detecting a ground level in the square block in accordance with a statistical processing with use of a histogram, considering the number of pixels of the image sensing elements of the image sensing section 20 and the size of the image data to be processed. In this embodiment, each side of the square block has 128 pixels.

If it is judged that no fractional block is generated, namely, zone-dividing processing is not necessary (NO in Step #36), the controller 126 proceeds to Step #38. On the other hand, if it is judged that a fractional block or blocks is or are generated, namely, zone-dividing processing is necessary (YES in Step #36), the controller 126 divides the image data 60 into the first-zone image data 61 having a number of pixels in horizontal and vertical directions equal to an integral multiple of the number of pixels corresponding to the respective sides of a square block in horizontal and vertical directions, and the second-zone image data 62 (remainder of the image data 60) with use of the zone-dividing section 142, and stores the first-zone image data 61 in a storage region corresponding to a predetermined address of the image memory 22. Further, the controller 126 stores information indicating that the image data 60 is divided into a storage region corresponding to a predetermined address of the storage section 25 (Step #37). For instance, if the image data 60 has a size of 1,960 pixels×1,440 pixels, and the first-zone image data 61 is extracted in such a manner that the side on the first-zone image data 61 in horizontal direction has a number of pixels equal to an integral multiple (≦15) of 128 pixels and the side thereof in vertical direction has a number of pixels equal to an integral multiple (≦12) of 128 pixels, then, the first-zone image data 61 is dividable by a square block. As will be described later, the ground level in a fractional block of the second-zone image data 62 is allocated based on the ground level in the square block of the first-zone image data 61. It is preferable to extract the first-zone image data 61 with a possible maximal size in the aspect of suppressing image deterioration. In view of this, the controller 126 extracts the first-zone image data 61 from the image data 60 to have a size corresponding to 1,920 pixels×1,408 pixels, wherein 1,920 is 15 times of 128, and 1,408 is 11 times of 128. In this embodiment, the first-zone image data 61 is set substantially in a central part of the image data 60, as shown in FIG. 5A.

Next, the controller 126 converts image data of R, G, B into brightness data (Y data) and color-difference data (Cr data, Cb data) in accordance with the following mathematical expressions 3 to 5, respectively with use of the RGB/YCrCb converting section 149 (Step #38).

Y=0.3R+0.59G+0.11B Ex. 3

Cr=R−Y Ex. 4

Cb=B−Y Ex. 5

Then, as shown in FIG. 11, the controller 126 divides the first-zone image data 61 (block calculating region 64) into a number of square blocks, wherein the block calculating region 64 is extracted by removing a peripheral part from the image data 60 based on the number of pixels which is equal to an integral multiple of the number of pixels corresponding to a side of a square block. If zone-dividing processing is unnecessary with respect to the image data to be processed (NO in Step #36), the operation in Step #38 is implemented with respect to the image data 60 itself (in this case, removal of peripheral part is not required). Removing a peripheral part from the image data 60 according to the abovementioned manner to set the central part of the image data 60 as the block calculating region 64 dividable by a square block is for the same reason as in setting the central part as the gain calculating region 63 for WB fine adjustment. The size for removing a peripheral part is determined based on an integral multiple of the number of pixels corresponding to one side of a square block is to render the central part dividable by a square block without generating a fractional portion. For instance, if the image data 60 has a size corresponding to 1,920 pixels×1,408 pixels, a peripheral part is removed based on 128 pixels corresponding to one side of a square block to set the central part having a size corresponding to 1,664 pixels×1,152 pixels. Thus, the central part is dividable by a square block whose one side has 128 pixels. Then, the central part is divided into 13 blocks in horizontal direction and 9 blocks in vertical direction, wherein each square block has a size of 128 pixels×128 pixels.

Next, the controller 126 calculates color saturation Sn and brightness Yn with respect to each square block in the central part (block calculating region) 64 every predetermined number of pixels in horizontal and vertical directions in accordance with the mathematical expressions 6 and 7 (Step #39).

$$\begin{matrix}Sn = \frac{{\sum }_{i} {\sum }_{j} ( \vert Cri , j \vert + \vert Cbi , j \vert )}{TOTAL NUMBER OF SAMPLING PIXELS} & Ex . 6 \\ Yn = \frac{{\sum }_{i} {\sum }_{j} Yi , j}{TOTAL NUMBER OF SAMPLING PIXELS} & Ex . 7\end{matrix}$$

The symbols i and j in the expressions 6 and 7 are a series of numerical values incremented by a predetermined number, and n is the ordinal number of square blocks. For instance, in the case where color saturation Sn and brightness Yn are calculated every 16 pixels, which is a divisor of 128 (number of pixels corresponding to one side of a square block), the numbers i, j are incremented by 16 such as 0, 15, 31, . . . . In this case, the total number of pixels for sampling in a square block is (128/16)×(128/16)=64.

Next, the controller 126 calculates an average value P1 of color saturation Sn, a standard deviation value P2 of brightness Yn, a standard deviation value P3 of color saturation Sn, a class P4 that is a peak in a histogram of brightness Yn, an integrated frequency P5 corresponding to brightness Yn in a range of (average value of brightness Yn±20%) in a histogram concerning brightness Yn, and an integrated frequency P6 corresponding to brightness Yn in a range lower than (average value of brightness Yn−20%) with use of the calculated color saturation Sn and brightness Yn (Step #39). In the histograms concerning the parameters P4, P5, P6, used is data classified into 64 gradations, which is equivalent to gradations obtained by subtracting the original gradations (=256) of brightness Yn by four. Next, the controller 126 calculates Mahalanobis distance d that is empirically created in a referential space based on a predetermined reference document image with use of six parameters P1 through P6, and judges whether the Mahalanobis distance d is greater than a threshold value ThM. If it is judged that d>ThM (NO in Step #40), the controller 126 judges that the image data 60 (or first-zone image data 61) is an image having a dark ground portion, an image in which a ground portion has a dark color, or a photographic image, and proceeds to Step #60. On the other hand, if d≦ThM (YES in Step #40), the controller 126 judges that the image data is a document image executable of image processing, and proceeds to Step #41.

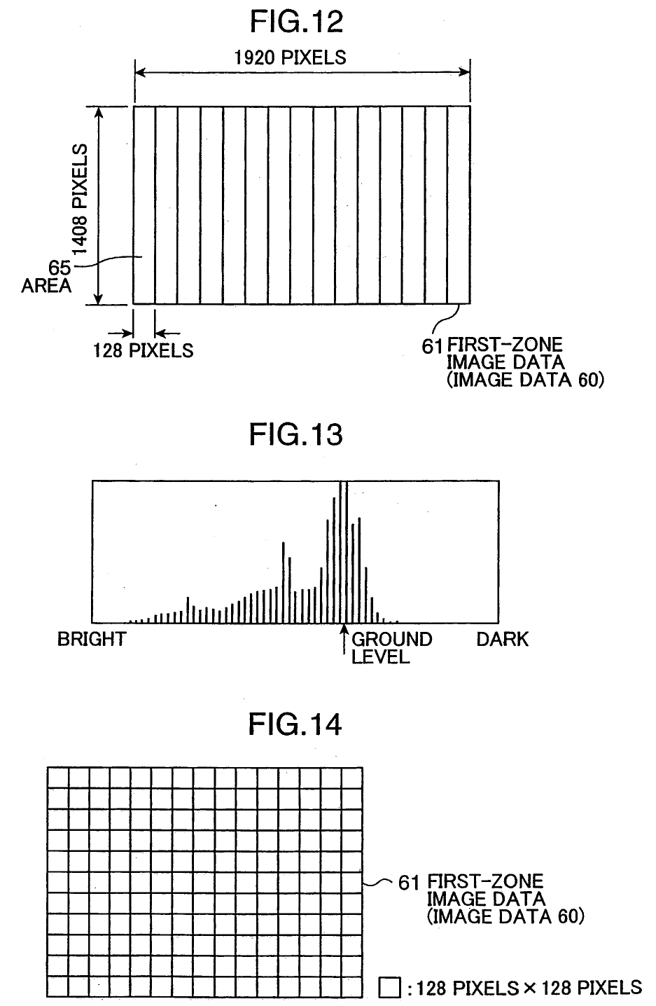

Next, the controller 126 divides the first-zone image data 61 (or image data 60) into a number of predetermined rectangular portions 65 each having a longer side in vertical direction (hereinafter referred to as “area 65”) with use of the block ground level determining section 143, and calculates a ground level VBL_E in each area 65 (Step #41). Hereinafter, the ground level VBL_E in an area 65 having a longer side in vertical direction is called as a vertical ground level VBL_E. More specifically, the vertical ground level VBL_E in each area 65 is calculated as follows. First, the controller 126 divides the first-zone image data 61 (or image data 60) into a number of areas 65 each having a longer side in vertical direction. It is preferable to set a shorter side in horizontal direction of each area 65 equal to one side of a square block in view of calculation of the ground level in a square block, which will be described later. In view of this, in the aforementioned example, as shown in FIG. 12, the controller 126 divides the first-zone image data 61 having 1,920 pixels×1,408 pixels into a certain number of areas 65 each having 128 pixels×1,408 pixels.

Next, the controller 126 converts the brightness data (Y data) into data having 64 gradations, which is obtained by subtracting the original gradations (=256) by four, every 8 pixels in horizontal direction in each area 65, and also converts the Y data into data having 64 gradations, which is obtained by subtracting the original gradations (=256) by four, every 8 pixels in vertical direction. Thus, the controller 126 creates a histogram concerning Y data having 64 gradations with respect to each area 65. For instance, a histogram as shown in FIG. 13 is created. In FIG. 13, the axis of abscissa denotes classes from 0 to 63 corresponding to 64 gradations of Y data, and the axis of ordinate denotes frequency. Next, the controller 126 searches for a class having a maximal frequency that meets the mathematical expressions 8 and 9 in the histogram, and re-converts the class having the maximal frequency into data having 256 gradations by multiplying the value of the class by four, and sets the re-converted data as a provisional vertical ground level VBL_E in the target area 65.

class>Thc1 Ex. 8

frequency>352 Ex. 9

The expression 8 is a formula for determining the range of the class which is supposed to correspond to a ground level. The ground level is a level of high brightness corresponding to a white-color portion (ground portion) such as a whiteboard and paper where characters and figures are not supposed to be written. Thc1 is empirically determined as a parameter for removing a class having low brightness, which is inappropriate as a ground level. For instance, in this embodiment, Thc1=70. The expression 9 is a formula for determining the range of the frequency in a class or classes that is or are supposed to correspond to a ground level. Since the ground level is obtained in terms of a class having a maximal frequency, it is necessary that the maximal frequency exceeds other frequencies in the case where the frequencies are uniformly distributed. In view of this, in this embodiment, a threshold value for determining the maximal frequency based on the assumption that the frequencies are uniformly distributed is calculated as 128×1,408/64/8=352 because an area 65 having 128 pixels×1,408 pixels is sampled out every 8 pixels both in horizontal and vertical directions thereof, and 256 gradations are converted into 64 gradations in this embodiment.

The shorter the sampling interval in Y data for creating a histogram, the higher the precision. Contrary to such improvement, however, this increases the number of Y data and requires an extended time for computation. Thus, precision and computation time are in a contradictory relationship. The sampling interval is determined considering well-balance between precision and calculation time. For instance, in the case where the controller 126 has a high computation speed, it may be possible to sample out Y data every 4 pixels both in horizontal and vertical directions. A sampling interval, which will be described later, is determined considering well-balance between precision and calculation time, as with the above case of determining the sampling interval in Y data.

Next, the controller 126 calculates a median with respect to the provisional vertical ground level VBL_E in three different areas 65 (a target area 65 and areas 65 adjoining the target area 65). For instance, let's assume that the provisional vertical ground level in a target area 65−n is VBL_E=200; the provisional vertical ground level in an area 65−(n−1) adjoining the target area 65−n in one direction is VBL_E=210; and the provisional vertical ground level in an area 65−(n+1) adjoining the target area 65−n in the other direction is VBL_E=220. Then, the median in these three areas 65 is 210. The above calculation is expressed as median(200, 210, 220)=210. A median with respect to the provisional vertical ground levels VBL_E in the target area 65−n, and the two adjoining areas 65−(n−1), 65−(n+1) is set as a vertical ground level VBL_E in the target area 65−n. The controller 126 implements the median calculation processing with respect to each area 65 to obtain a vertical ground level VBL_E in each area 65. Further, the controller 126 calculates an average value AVBL_E of the vertical ground levels VBL_E in the respective areas 65 by excluding a maximal value and a minimal value among the obtained vertical ground levels VBL_E in the areas 65. In the case where the vertical ground level VBL_E in the adjoining area 65−n(−1) (65−(n+1)) is deviated from the average value AVBL_E by a predetermined value (e.g. 50) or more, the controller 126 replaces the vertical ground level VBL_E in the target area 65−n with the vertical ground level VBL_E in the adjoining area 65−n(−1) which is adjoined left to the target area 65−n in FIG. 12.

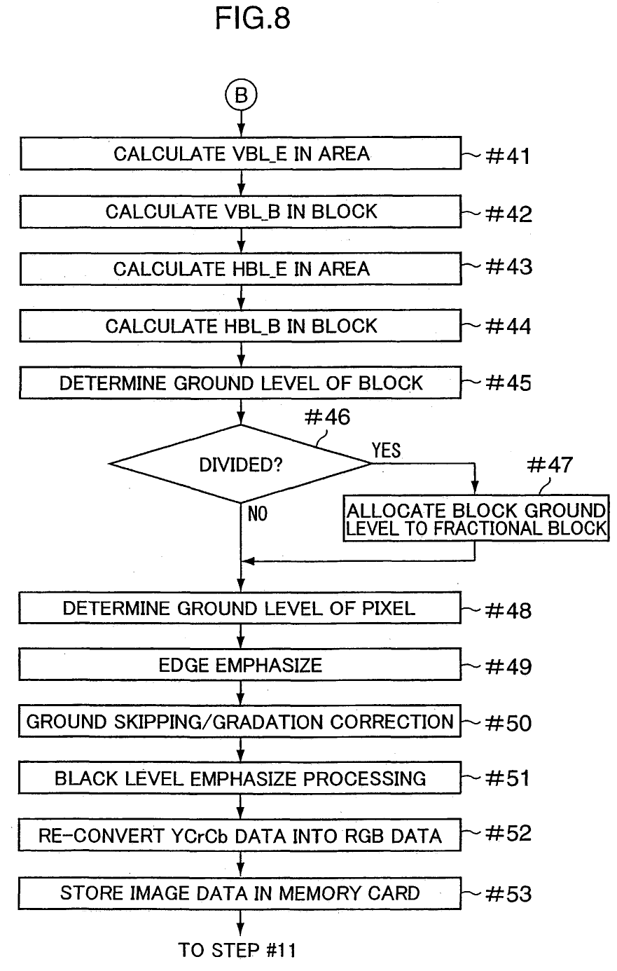

In this way, the controller 126 calculates the vertical ground level VBL_E in each area 65 (Step #41 in FIG. 8).

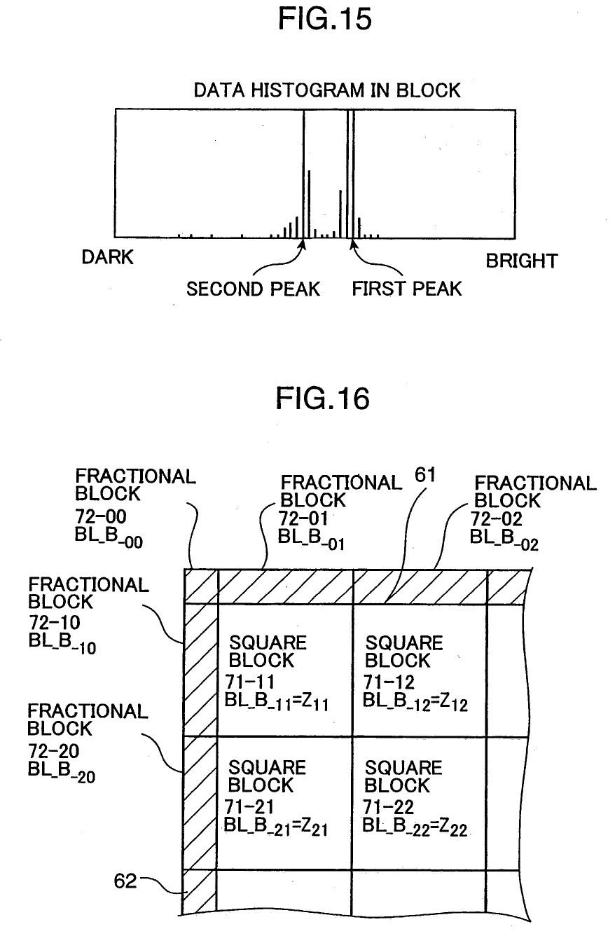

Next, the controller 126 divides each area 65 into a number of square blocks with use of the block ground level determining section 143, and calculates a vertical ground level VBL_B in each square block (Step #42). More specifically, the vertical ground level VBL_B in each square block is calculated as follows. First, as shown in FIG. 14, the controller 126 divides each area 65 into a certain number of square blocks. In the example of FIG. 14, the controller 126 divides an area 65 having 128 pixels×1,408 pixels into a number of square blocks each having 128 pixels×128 pixels. Next, the controller 126 converts Y data into data having 64 gradations obtained by subtracting the original gradations (=256) by four every 8 pixels in horizontal direction, and also converts the Y data into data having 64 gradations obtained by subtracting the original gradations (=256) by four every 8 pixels in vertical direction. The controller 126 creates a histogram concerning Y data having 64 gradations with respect to each square block. For instance, a histogram as shown in FIG. 15 is created. In FIG. 15, the axis of abscissa denotes classes from 0 to 63 corresponding to 64 gradations of Y data, and the axis of ordinate denotes frequency.

Next, the controller 126 checks up the histogram in the order from high-brightness side to low-brightness side, searches for a class that satisfies the mathematical expressions 10, 11 and the requirement that “the target class has a possible maximal frequency which is larger than respective frequencies in classes one-, two-, three-steps lower in brightness than the target class”, re-converts the value of the class into data having 256 gradations by multiplying the value of the class by four, and sets the re-converted data as a first peak brightness.

class>Thc2 Ex. 10

frequency>32 Ex. 11

Thc2 is a numerical value obtained based on a theory analogous to the theory for obtaining Thc1. For instance, in this embodiment, Thc2=70. The frequency 32 in the expression 11 is a numerical value obtained based on a theory analogous to the theory for obtaining the frequency 384 in the expression 9. Specifically, in this embodiment, assuming that the frequencies are uniformly distributed, a threshold value that satisfies the aforementioned requirement is calculated as 128×128/64/8=32 because 256 gradations that have been sampled out every 8 pixels both in horizontal and vertical directions in a square block having 128 pixels×128 pixels are converted into 64 gradations.

Further, the controller 126 checks up the histogram in the order from the class corresponding to the first peak brightness toward low-brightness side, searches for a class that meets the mathematical expressions 12, 13 and the requirements that “the target class has a possible maximal frequency which is larger than the frequency in a class one-step higher in brightness than the target class” and “the target class has the possible maximal frequency which is larger than respective frequencies in classes one-, two-, three-steps lower in brightness than the target class”, re-converts the target class into data having 256 gradations by multiplying the value of the class by four, and sets the re-converted data as a second peak brightness.

class>Thc3 Ex. 12

frequency>32 Ex. 13

Thc3 is a numerical value obtained based on a theory analogous to the theory for obtaining Thc1. Since the second peak brightness should be lower than the first peak brightness in this embodiment, a threshold value for Thc3 is 80.

Next, the controller 126 compares the first peak brightness and the second peak brightness with the vertical ground level VBL_E in the area 65 within which the target square block is located, respectively, and sets the peak brightness which is closer to the vertical ground level VBL_E in the area 65 as a provisional vertical ground level in the target square block. For instance, if the first peak brightness is 220, the second peak brightness is 190, and the vertical ground level in the area 65 within which the target square block is located is 200, the second peak brightness is closer to the vertical ground level in the area 65. Therefore, the provisional vertical ground level VBL_B in the target square block is 190.

In the case where there is a difference of 60 or more between the selected peak brightness and the vertical ground level VBL_E in the area 65 within which the target square block is located, the controller 126 replaces the provisional vertical ground level VBL_B in the square block with the vertical ground level VBL_E in the area 65 within which the square block is located. On the other hand, in the case where there is a difference of not smaller than 40 and smaller than 60 between the selected peak brightness and the vertical ground level VBL_E in the area 65 within which the square block is located, the controller 126 replaces the provisional vertical ground level VBL_B in the square block with an average value of the provisional vertical ground level VBL_B in the square block and the vertical ground level VBL_E in the area 65 within which the square block is located. For instance, if the first peak brightness is 160, the second peak brightness is 110, and the vertical ground level in the area 65 is 230, the vertical ground level in the area 65 and the first peak brightness are closer to each other, but a difference therebetween is more than 60 (namely, 230−160=70). Furthermore, for instance, if the first peak brightness is 180, the second peak brightness is 110, and the vertical ground level in the area 65 is 230, a difference between the vertical ground level in the area 65 and the first peak brightness is not smaller than 40 and smaller than 60 (namely, 230−180=50). Therefore, in this case, the provisional vertical ground level VBL_B in the square block is: (180+230)/2=205.

In this way, the provisional vertical ground levels VBL_B with respect to all the square blocks of the first-zone image data 61 (or image data 60) are calculated. Thereafter, the controller 126 calculates an average value of the provisional vertical ground level VBL_B with respect to a target square block and four square blocks adjoining the target square block in horizontal and vertical directions in which a maximal value and a minimal value are excluded, and sets the calculated average value as a vertical ground level VBL_B in the target square block. For instance, let's assume that the provisional vertical ground level VBL_B in the target square block is 200, the provisional vertical ground levels VBL_B in square blocks adjoining the target square block in horizontal direction are 210, 220, and the provisional vertical ground levels VBL_B in square blocks adjoining the target square block in vertical direction are 190, 210. Then, the average value (200+210+210)/3=207 in which the maximal value (=220) and the minimal value (=190) are excluded is set as the vertical ground level VBL_B in the target square block.

In a case where a target square block is located in a peripheral part of the image data 60, and a case where there is a difference of a predetermined value (e.g. 50) or more between the provisional vertical ground level VBL_B in a square block and the average value AVBL_E of the vertical ground level VBL_E in the area 65 within which the square block is located, the controller 126 sets the vertical ground level VBL_B in a square block adjoining inwardly of the square block as the vertical ground level VBL_B in the target square block without implementing the aforementioned calculation of obtaining the average value. For instance, the vertical ground level VBL_B in a square block immediately below a square block in the uppermost row in FIG. 14 is allocated as the vertical ground level VBL_B in the square block in the uppermost row. Further, the vertical ground level VBL_B in a square block which is located at a lower left side relative to an uppermost right-end square block is allocated as the vertical ground level VBL_B in the uppermost right-end square block.

In this way, the controller 126 calculates the vertical ground level VBL_B with respect to each square block in the areas 65 of the first-zone image data 61 (or image data 60).

Next, referring back to FIG. 8, the controller 126 divides the first-zone image data 61 (image data 60) into a certain number of areas 65 each having a longer side in horizontal direction with use of the block ground level determining section 143, and calculates a ground level HBL_E in each area 65 (hereinafter, called as “horizontal ground level HBL_E”) in the similar manner as calculating the vertical ground level VBL_E in each area 65 in Step #41 (Step #43). In this case, the area 65 has 1,920 pixels×128 pixels by dividing image data of 1,920 pixels×1,408 pixels by 128 each.

Then, the controller 126 divides each area 65 having a longer side in horizontal direction into a certain number of square blocks with use of the block ground level determining section 143, and calculates a horizontal ground level HBL_B in each square block in the similar manner as calculating the vertical ground level VBL_B in each square block in Step #42 (Step #44).

The controller 126 calculates the ground level both in horizontal and vertical directions with respect to one common square block by implementing a series of controls in Steps #41 through #44.

Next, the controller 126 compares the vertical ground level VBL_B and the horizontal ground lever HBL_B in a square block with use of the block ground level determining section 143, and sets the ground level whose value (brightness) is higher than the other, as a ground level BL_B in the square block. In this way, the controller 126 integrates the values obtained in Steps #42 and #44 (Step #45).

Thus, the first-zone image data 61 (or image data 60) is divided into a number of square blocks, and the ground level BL_B which is a preprocessing value with respect to each square block is obtained. Now, the controller 126 calculates a ground level BL_B which is a preprocessing value with respect to a fractional block in the second-zone image data 62.

First, referring to FIG. 8, the controller 126 judges whether zone-dividing processing has been implemented with respect to the image data 60 by retrieval operation in the storage region corresponding to the predetermined address in the storage section 25 (Step #46). If it is judged that zone-dividing processing is not executed (NO in Step #46), the controller 126 proceeds to Step #48. On the other hand, if it is judged that zone-dividing processing is executed (YES in Step #46), the controller 126 allocates a ground level in a fractional block of the second-zone image data 62 based on the ground level BL_B in the square block of the first-zone image data 61 with use of the fractional block ground level allocating section 144 (Step #37).

FIG. 16 is an illustration showing a corner portion of an image to explain a relation between the ground level in a square block and the ground level in a fractional block.

For instance, the ground level BL_B=z in a square block 71 belonging to the first-zone image data 61 adjoining a target fractional block 72 is allocated as the ground level BL_B in the fractional block 72. The ground level BL_B in a square block of the first-zone image data 61 which is closest to a fractional block 72 at a corner of the second-zone image data 62 is allocated as the ground level BL_B in the corner fractional block 72.

Specifically, when the image data 60 is divided into the first-zone image data 61, which is located in the central part of the image data 60, and the second-zone image data 62, as shown in FIG. 5A, the second-zone image data 62 is located in a periphery of the image data 60, as shown in FIG. 16. The ground level in a block (square block 71 or fractional block 72) located in the i-th row, j-th column (i, j are an integer including 0) in the first-zone image data 61 and in the second-zone image data 62 is represented as BL_B₋ᵢⱼ=Zᵢⱼ. Then, the ground level BL_B₋ᵢⱼ=Zᵢⱼ which is the ground level in the square block 71-1j at the 1^{st} row is allocated as the ground level BL_B₋₀ⱼ in the fractional block 72-0j at the 0-th row, and the ground level BL_B₋ᵢ₁=Zᵢ₁ which is the ground level in the square block 71-i1 at the 1^{st} column is allocated as the ground level BL_B₋ᵢ₀ in the fractional block 72-i0 at the 0-th column. The ground level BL_B₋₁₁=Z₁₁ which is the ground level in the square block 71-11, namely, a corner square block of the first-zone image data 61 closest to the corner fractional block 72-00 of the second-zone image data 62 is allocated as the ground level BL_B₋₀₀ in the fractional block 72-00.

Alternatively, for instance, the ground level BL_B in a fractional block 72 may be obtained by linear extrapolation (outwardly and linearly extensive interpolation) with use of the ground level BL_B in a square block 71 of the first-zone image data 61 adjoining the fractional block 72 in a certain direction, and the ground level BL_B in one or more square blocks 71 adjoining the square block 71 in the certain direction. The ground level BL_B in a corner fractional block 72 may be obtained by averaging the ground level in two fractional blocks 72 adjoining the corner fractional block 72.

More specifically, in FIG. 16, in case of implementing linear extrapolation to obtain the ground level BL_B₋₀ⱼ in the fractional block 72-0j at the 0-th row with use of the ground levels BL_B in two square blocks of the first-zone image data 61, Zᵢⱼ−(Z₁ⱼ+Z₂ⱼ)/2 is adopted, wherein Zᵢⱼ (Z₁ⱼ+Z₂ⱼ)/2 is obtained-by linear extrapolation with use of the ground level BL_B₋₁ⱼ=Zᵢⱼ in the corresponding square block 71-1j at the 1^{st} row and the ground level BL_B₋₂ⱼ=Z₂ⱼ in the corresponding square block 71-1j at the 2^{nd} row. In case of implementing linear extrapolation to obtain the ground level BL_B₋ᵢ₀ in the fractional block 72-i0 at the 0-th column with use of the ground levels BL_B in two square blocks in the first-zone image data 61, Zᵢ₁−(Zᵢ₁+Zᵢ₂)/2 is adopted, wherein Zᵢ₁ (Zᵢ₁+Zᵢ₂)/2 is obtained by linear extrapolation with use of the ground level BL_B₋ᵢ₁=Zᵢ₁ in the corresponding square block 71-i1 at the 1^{st} column and the ground level BL_Bᵢ₂=Zᵢ₂ in the corresponding square block 71-i2 at the 2^{nd} column. A value (Z₁₁+Z₁₁)/2 is allocated as the ground level BL_B_{—00} in the corner fractional block 72-00, wherein the value (Z₁₁+Z₁₁)/2 is obtained by averaging the ground level BL_B₋₀₁ in the fractional block 72-01 adjoining the corner fractional block 72-00 in horizontal direction, and the ground level BL_B₋₁₀ in the fractional block 72-10 adjoining the corner fractional block 72-00 in vertical direction.

In this way, the controller 126 allocates the ground level BL_B in each fractional block 72 of the second-zone image data 62 based on the ground level BL_B in a square block or blocks 71 of the first-zone image data 61.

Next, referring back to FIG. 8, the controller 126 calculates the ground level with respect to each pixel based on the ground levels in the fractional blocks 72 and the square blocks 71 with use of the pixel ground level determining section 145 (Step #48).

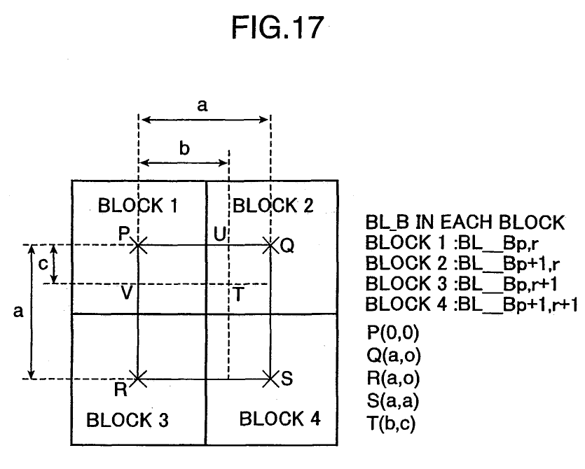

Specifically, let it be assumed that the ground level in a block (square block or fractional block) at the p-th row, r-th column is BL_B_{p,r}. Then, as shown in FIG. 17, the controller 126 defines a region having four vertices corresponding to respective center pixels P, Q, R, S in a block 1 at the p-th row, r-th column, a block 2 at the (p+1)-th row, r-th column, a block 3 at the p-th row, (r+1)-th column, and a block 4 at the (p+1)-th row, (r+1)-th column, and calculates the ground level BL_T_{a,b} of each pixel T_{a,b} every 4 pixels both in horizontal and vertical directions in the defined region based on the ground level BL_B_{p,r} in the block 1, the ground level BL_B_{p+1,r} in the block 2, the ground level BL_B_{p,r+1} in the block 3, and the ground level BL_B_{p+1,r+1} in the block 4 by implementing linear interpolation (in accordance with the mathematical expression 14).

$$BL\_Ti , j = \frac{\begin{matrix}[ ( a - c ) \times \{ ( a - b ) \times BL\_Bp , r + b \times BL\_Bp + 1 , r \} + \\ C \times \{ ( a - b ) \times BL\_Bp , r + 1 + bBL\_Bp + 1 , r + 1 \} ]\end{matrix}}{{a}^{2}} \qquad Ex . 14$$

Referring to FIG. 17, assuming an xy coordinate system in which a point P, an intersecting point of x-axis defined by PQ and y-axis defined by PR orthogonal to each other, is designated as origin of coordinates, a is a length of a side of the region defined by PQRS corresponding to four vertices, b is a coordinate value on x-axis with respect to a target pixel T_{a,b} for computation, and c is a coordinate value on y-axis with respect to the pixel T_{a,b}.

As mentioned above, the ground level BL_T of a pixel sampled out every 4 pixels both in horizontal and vertical directions is calculated with use of the ground levels BL_B_{p,r}, BL_B_{p+1,r}, BL_B_{p,r+1}, and BL_B_{p+1,r+1} in the four blocks 1, 2, 3, 4 adjoining each other. Accordingly, the digital camera 100 in this embodiment is advantageous in suppressing discontinuity in image reproducibility due to a difference in ground level BL_B between or among blocks.

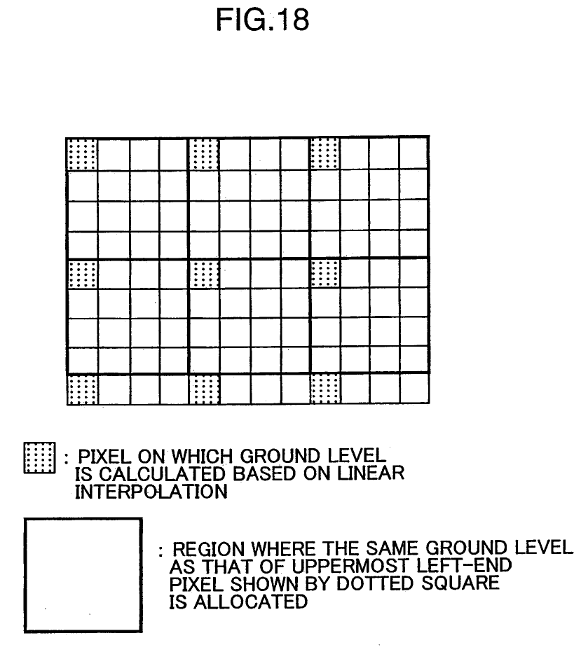

Calculating the ground level BL_T of a pixel every 4 pixels both in horizontal and vertical directions means that the ground level BL_T of a pixel is calculated within a cell consisting of 4 pixels×4 pixels, as shown in FIG. 18. The controller 126, then, sets the ground level BL_T of the pixel within the cell whose ground level has been calculated and thus known, as the ground level BL_T of the other pixels within the cell whose ground level has not been calculated and thus unknown.

As is obvious from FIG. 17, the pixels whose ground levels BL_T are computable are pixels located in a region defined by inward half of one side in horizontal direction of a fractional block and inward half of one side in vertical direction thereof, as is exemplified by a central region defined by PQRS in the four blocks 1, 2, 3, 4. As shown in FIG. 5A, when the first-zone image data 61 is defined in a central part of the image data 60, the ground level BL_T is computable with respect to a central region having 1,940 pixels×1,424 pixels.

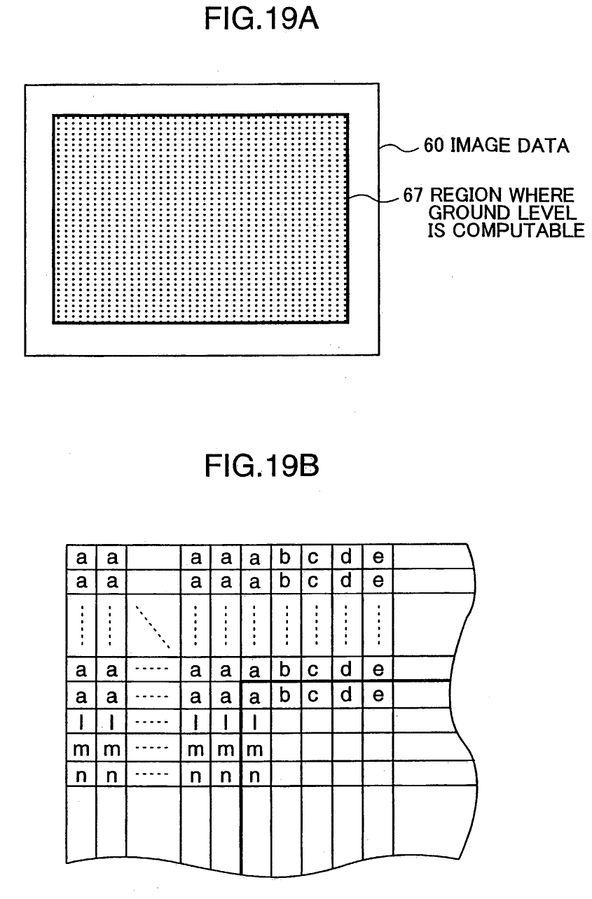

Next, the ground levels BL_T of pixels in a peripheral region of the image data 60 excluding the central region are determined as follows. As shown in FIGS. 19A and 19B, the controller 126 allocates the ground level BL_T of a pixel located on the outermost side of the central region defined by the bold solid line to the ground level BL_T of a pixel in the peripheral region. Specifically, the ground level BL_T of a pixel on the horizontally outermost side of the central region is used as the ground levels of vertically corresponding pixels in a horizontally extending peripheral region, and the ground level BL_T of a pixel on the vertically outermost side of the central region is used as the ground levels of horizontally corresponding pixels in a vertically extending peripheral region. Further, the ground level of a pixel at a corner on the outermost side of the central region is used as the ground level of a corner pixel of the peripheral region.

In this way, the controller 126 determines the ground levels BL_T of all the pixels within the image data 60.

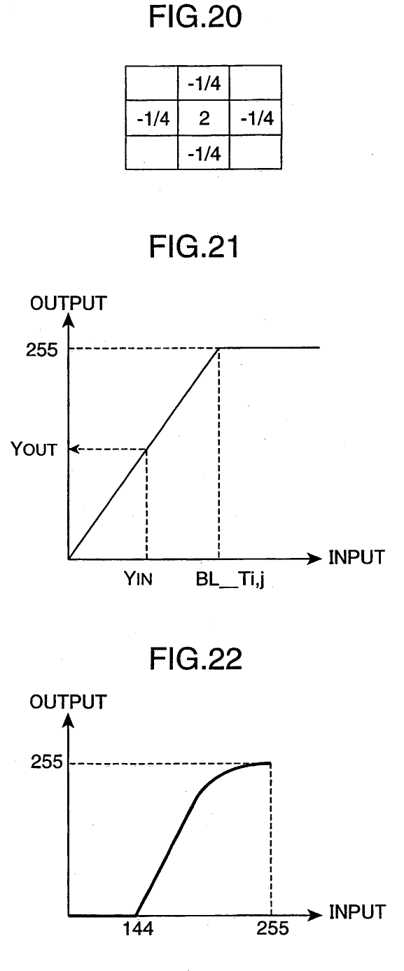

Next, referring back to FIG. 8, the controller 126 implements edge emphasizing processing with respect to brightness data (Y data) of each pixel with use of a filter by using the edge emphasizing section 150 (Step #49). It is preferable to adopt an optimal filter depending on the required level of edge emphasizing. FIG. 20 shows an example of a filter capable of magnifying the brightness level of a target pixel by two and reducing the brightness level of four pixels adjacent to the target pixel in horizontal and vertical directions by four.

Next, the controller 126 implements ground skipping/gradation correction with respect to each pixel based on a ground skipping/gradation correction characteristic by using the ground skipping/gradation correcting section 146 (Step #50). Specifically, according to the ground skipping/gradation correction characteristic, as shown in FIG. 21, while the brightness data (Y data) of the pixel T_{a,b} is from zero to the ground level BL_T_{a,b} of the pixel T_{a,b}, input brightness data Yin is linearly converted, and when the brightness data of the pixel T_{a,b} exceeds the ground level BL_T_{a,b}, input brightness data Yin is converted to a maximal brightness level (e.g. 255 in gradations of 256). More specifically, the brightness data (Y data) of the pixel T_{a,b} is determined by linear conversion with use of the ground level BL_T_{a,b} of the pixel T_{a,b} as a threshold value or by conversion of the brightness level to a possible maximal brightness level. Namely the threshold value is a value inherent to the pixel T_{a,b}. For instance, if the input brightness data is not larger than the threshold value (ground level BL_T_{a,b} of the pixel T_{a,b}), namely, Yin≦BL_T_{a,b}, the output Yout is linearly converted as (255×Yin)/BL_T_{a,b}, wherein 255 is a gradation corresponding to a maximal brightness, and if the input brightness data Yin exceeds the threshold value (ground level BL_T_{a,b} of the pixel T_{a,b}), namely, Yin>BL_T_{a,b}, the output Yout is converted to 255 (gradation corresponding to a maximal brightness).

Next, referring back to FIG. 8, the controller 126 implements black level highlight processing with respect to each pixel with use of the black level highlighting section 151 (Step #51). Black level highlight processing is to convert Y data with e.g. use of a correction characteristic as shown in FIG. 22. As shown in FIG. 22, the correction characteristic used in black level highlight processing is a characteristic in which input brightness data Yin having a brightness level lower than a threshold value (144 for example in FIG. 22) is converted to a black level.

Next, the controller 126 re-converts the brightness data (Y data), and the color-difference data (Cr data and Cb data) into R, G, B data in accordance with the following mathematical expressions 15, 16, 17, respectively (Step #52).

R=Y+Cr Ex. 15

G=Y−0.51Cr−0.19Cb Ex. 16

B=Y+Cb Ex. 17

Subsequently, the controller 126 stores the processed image data in the memory card 13 with use of the card controlling section 24 or its equivalent (Step #53), and the control in the controller 26 is returned to Step #11.

As mentioned above, the digital camera 100 in accordance with the first embodiment is so configured as to divide a sensed image into a number of square blocks without generating a fractional portion. Accordingly, a value necessary for ground skipping/gradation correction processing can be easily calculated block by block. This is advantageous in facilitating image processing, namely, in raising the contrast of image data corresponding to information such as characters relative to a white portion such as a whiteboard to reproduce the information clearly in case of reproducing the information of an arbitrary size and in suppressing illumination distribution non-uniformity to provide viewers with easily viewable information. With the arrangement as mentioned above, the digital camera 100 can comply with a demand of reproducing character image data with image quality of high information legibility rather than descriptiveness. (Image Processing Concerning Image in which Ground Skipping/Gradation Correction is Un-Executable, WB Fine Adjustment is Un-Executable, Image having Dark Ground Portion, Image having Ground Portion of Dark Color, or Photographic Image)

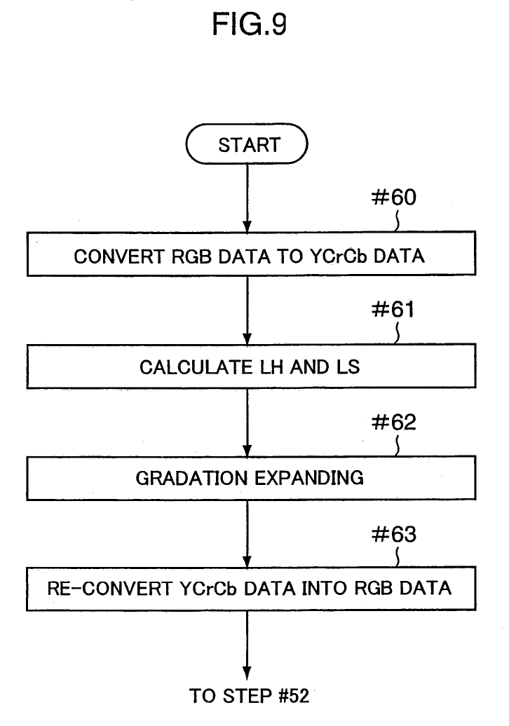

In case of processing an image in which ground skipping/gradation correction is un-executable, an image in which WB fine adjustment is un-executable, an image having a dark ground portion, an image having a ground portion of a dark color, or a photographic image, referring to FIG. 9, the controller 126 converts R, G, B data of image data into brightness data (Y data), and color-difference data (Cr data and Cb data) in accordance with the mathematical expressions 3, 4, 5, respectively (Step #60).

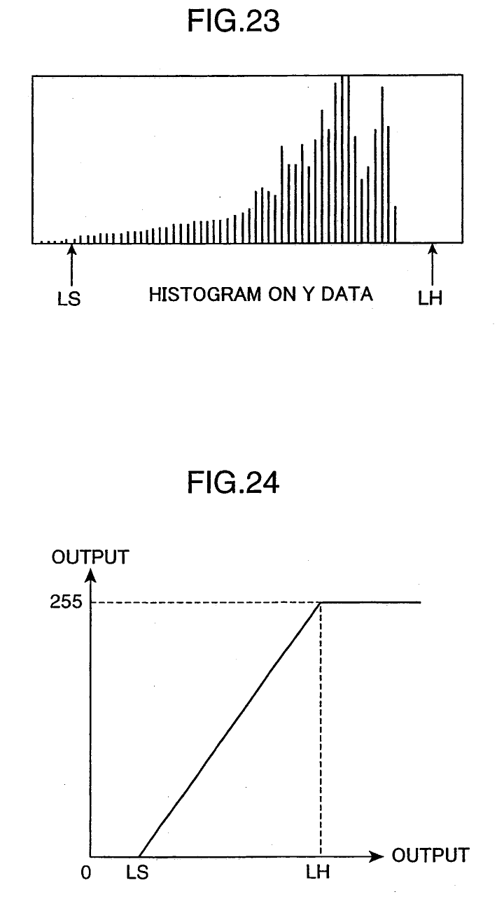

Next, the controller 126 calculates highlight level LH and shadow level LS with use of the LH/LS calculating section 147 (Step #61). Specifically, the controller 126 converts brightness data (Y data) into data having 64 gradations with respect to the entire image data 60, wherein 64 gradations are obtained by subtracting the original gradations (=256) by four. Next, the controller 126 creates a histogram as shown in FIG. 23 with respect to the Y data having 64 gradations. Then, the controller 126 integrates the frequencies in the order from the maximal class (=63) corresponding to a highest brightness level toward a lower brightness level, searches for a class at which the integrated frequency exceeds several percent (e.g. 1%) of the total frequency, and re-converts the value of the class into data having 256 gradations by multiplying the value of the class by four, and sets the data having 256 gradations as highlight level LH. Next, the controller 126 integrates the frequency from a lowermost class (=0) corresponding to a lowermost brightness level toward a higher brightness level, searches for a class at which the integrated frequency exceeds several percent (e.g. 1%) of the total frequency, re-converts the value of the class into data having 256 gradations by multiplying the value of the class by four, and sets the data having 256 gradations as shadow level LS.

Subsequently, referring back to FIG. 9, the controller 126 correctively expands the gradation with respect to each pixel based on a gradation expansion correction characteristic with use of the gradation expanding/correcting section 152 (Step #62). The gradation expansion correction characteristic is such that, as shown in FIG. 24, while the brightness level is from zero to the shadow level LS, the input brightness data Yin is converted into a black level, and while the brightness level is from the shadow level LS to the highlight level LH, the input brightness data Yin is linearly converted, and when the brightness level exceeds the highlight level LH, the input brightness data Yin is converted into a maximal brightness level (e.g. 255 in 256 gradations).

Next, the controller 126 re-converts the brightness data (Y data) and the color-difference data (Cr data and Cb data) into R, G, B data in accordance with the mathematical expressions 15, 16, 17, respectively (Step #63), and the control in the controller 126 is returned to Step #52.

As mentioned above, in the digital camera 100 in accordance with the first embodiment, judgment is automatically made as to whether the image has a size executable of ground skipping/gradation correction in Step #33, whether the image has a size executable of WB fine adjustment in Step #34, and whether the image has a size executable of document image processing in Step #40, and an appropriate gradation expanding/correction processing is implemented in Steps #60 through #63 depending on the condition where the image is an image in which ground skipping/gradation correction is un-executable, an image in which WB fine adjustment is un-executable, and an image in which document image processing is un-executable such as an image having a dark ground portion, an image having a ground portion of a dark color, or a photographic image. With this arrangement, even if an image to be processed is any one of the aforementioned images, the digital camera 100 in accordance with the first embodiment is capable of reproducing images of excellent descriptiveness by converting a sensed image into image data having a suitable number of gradations by efficiently utilizing the range of gradations (in this embodiment, 256 gradations).

Now, another embodiment of this invention is described.

(Second Embodiment)

The digital camera 100 in accordance with the first embodiment implements an image processing by implementing zone-dividing with respect to a sensed image in such a manner that image data is dividable into a plurality of square blocks without generating a fractional portion. A digital camera in accordance with the second embodiment of this invention implements an image processing by varying the size of a sensed image in such a manner that image data is dividable into a plurality of square blocks without generating a fractional portion.

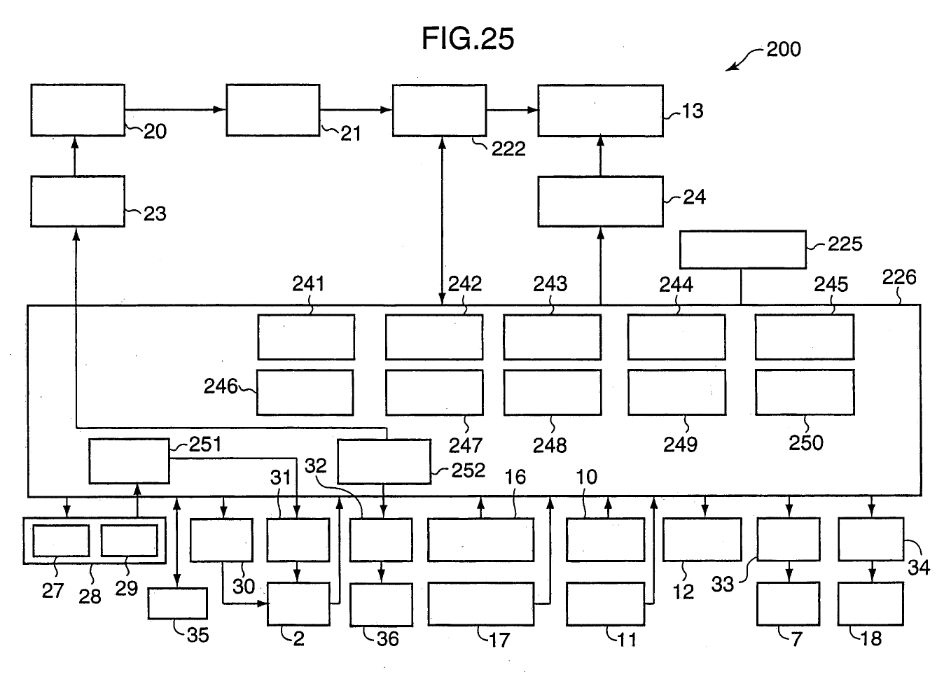

Since an external appearance of the digital camera 200 in the second embodiment is substantially the same as that of the digital camera 100 in the first embodiment, elements in the second embodiment identical to those in the first embodiment are denoted at the same reference numerals, and description thereof is omitted herein. FIG. 25 is a block diagram of the digital camera 200. The digital camera 200 basically comprises, as shown in FIG. 25, an image sensing section 20, an A/D converting section 21, an image memory 222, a memory card 13, an image sensing driving section 23, a card controlling section 24, a storage section 225, a controller 226, a distance metering section 28, a zoom driving section 30, a lens driving section 31, an aperture driving section 32, a photographing mode setting switch 16, a shutter button 10, a photographing/reproducing switch 12, a light emission controlling section 33, an LCD driving section 34, a light metering section 35, a taking lens 2, an aperture 36, an image resolution setting switch 17, a zoom switch 11, a flashlight section 7, and an LCD section 18.

The controller 226 comprises an image size judging section 241, an image size varying section 242, a ground level determining section 243, a ground skipping/gradation correcting section 244, an LH/LS calculating section 245, a WB fine adjustment section 246, an RGB/YCrCb converting section 247, an edge emphasizing section 248, a black level emphasizing section 249, a gradation expanding/correcting section 250, an AF control value calculating section 251, and an exposure value calculating section 252. The image memory 222, the card controlling section 24, the storage section 225, and the controller 226 constitute an image processing device in accordance with the second embodiment of this invention.

Elements of the digital camera 200 having different functions from those of the digital camera 100 in the first embodiment are described as follows.

The image memory 222 is a memory which is connected with the controller 226 and temporarily stores image data to implement an image processing. The image memory 222 implements a predetermined processing with respect to image data, which will be described later, and outputs the processed image data to the memory card 13. The image memory 222 includes e.g. an RAM, and has a sufficient storage capacity of storing image data corresponding to a frame of a sensed image after size varying in view of e.g. integral processing.

The storage section 225 is a memory which is connected with the controller 226 and stores a variety of programs necessary for operating the digital camera 200, and various data such as data to be processed while a program is running. The storage section 225 is comprised of e.g. an RAM and an ROM.

The controller 226 includes a microprocessor, and centrally controls photographing and image processing operations of the digital camera 200 by the elements 241 through 252. The image size judging section 241 detects the size of image data generated by sensing an object image, and judges whether the detected size is a size executable of image processing, a size executable of ground skipping/gradation correction, a size executable of WB fine adjustment, and a size necessary of size varying processing. The image size varying section 242 magnifies or reduces image data into a certain size. The ground level determining section 243 calculates the ground level of an area of image data in accordance with a statistical processing, calculates the ground level of a block, and then calculates the ground level of a pixel. Specifically, the ground level determining section 243 has a combined function of the block ground level determining section 143 and the pixel ground level determining section 145 in the first embodiment. The ground skipping/gradation correcting section 244, the LH/LS calculating section 245, the WB fine adjustment section 246, the RGB/YCrCb converting section 247, the edge emphasizing section 248, the black level emphasizing section 249, the gradation expanding/correcting section 250, the AF control value calculating section 251, and the exposure control value calculating section 252 respectively correspond to the ground skipping/gradation correcting section 146, the LH/LS calculating section 147, the WB fine adjustment section 148, the RGB/YCrCb converting section 149, the edge emphasizing section 150, the black level emphasizing section 151, the gradation expanding/correcting section 152, the AF control value calculating section 153, and the exposure control value calculating section 154. Accordingly, description on the elements 244 through 252 is omitted herein.

(Operation of the Second Embodiment)

Now, operation of the digital camera 200 provided with the image processing device in accordance with the second embodiment is described roughly and then in detail. First, operation of the digital camera 200 in the second embodiment is described roughly.

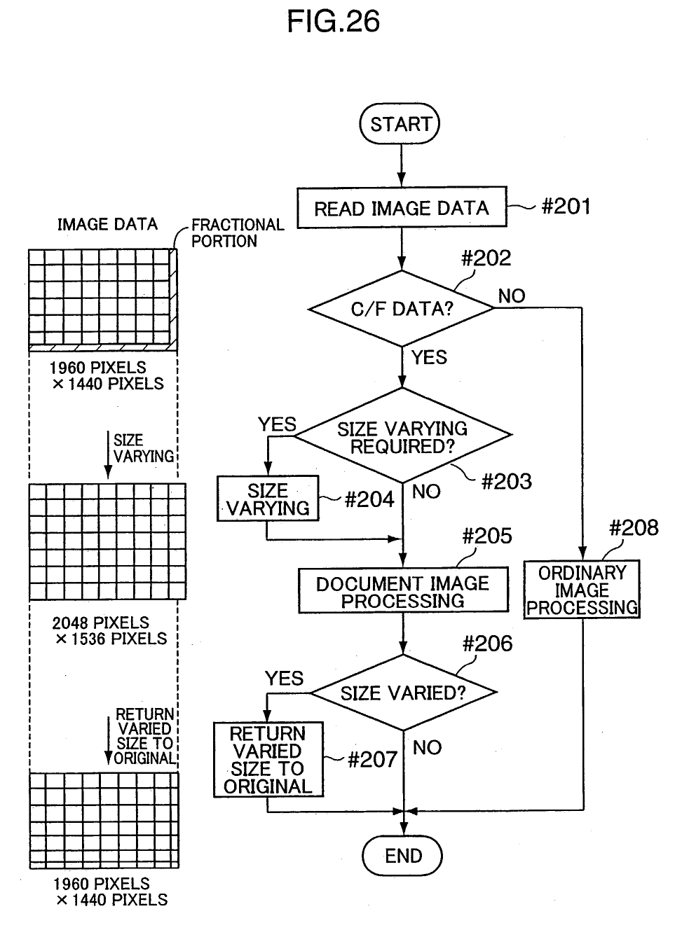

FIG. 26 is a flowchart showing a schematic operation of the image processing in the second embodiment.

Referring to FIG. 26, first, image data to be processed is read (Step #201). As with the case of the first embodiment, various image data can be read in the second embodiment.

Next, the controller 226 judges whether the size of the image data and the image data itself meet the requirements concerning document image processing. If it is judged that the image data is character/figure image data or the like that has been obtained by sensing information such as characters written on a whiteboard or the like (YES in Step #202), the controller 226 proceeds to Step #203. On the other hand, if it is judged that the image data is other than character/figure image data (NO in Step #202), the controller 226 proceeds to Step #208 where processing with respect to image data other than character/figure image data is implemented.

In Step #203, the controller 226 judges whether it is necessary to vary the size of the image data. If it is judged that the image data does not have a size equal to an integral multiple of the size of a reference block (YES in Step #203), the controller 226 proceeds to Step #204 and then to Step #205. On the other hand, if it is judged that the image data has a size equal to an integral multiple of the size of the reference block (NO in Step #203), the controller 226 proceeds to Step #205. For instance, in the case where the image data has a size corresponding to 1,960 pixels×1,440 pixels, and the reference block is a square block corresponding to 128 pixels×128 pixels, there is generated a fractional portion corresponding to 40 pixels in horizontal direction and 32 pixels in vertical direction. In such a case, size varying processing is necessary.

The size varying processing in Step #204 is such that the size of the image data is magnified or reduced so that the number of pixels of the image data after magnification/reduction both in horizontal and vertical directions equals to an integral multiple of the number of pixels corresponding to a corresponding side of a reference block. For instance, image data having 2,048 pixels×1,536 pixels is generated by magnifying the size of the image data by 2,048/1,960 in horizontal direction and by magnifying the size of the image data by 1,536/1,440 in vertical direction.

In Step #205, the controller 226 carries out a series of document image processing such as ground skipping/gradation correction processing for converting a brightness level exceeding a predetermined threshold value to possible a maximal brightness level with respect to each pixel, edge emphasizing processing, and black level highlight processing for converting a brightness level not exceeding the predetermined threshold value to a black level so as to reproduce character information clearly. In this embodiment, the threshold value in ground skipping/gradation correction processing is set pixel by pixel based on the ground level with respect to each block after calculating the ground level with respect to each block. Alternatively, the threshold value can be appropriately set because image data after size magnification/reduction has a number of pixels both in horizontal and vertical directions equal to an integral multiple of the number of pixels corresponding to a corresponding side of a reference block.

The controller 226 judges whether the image data after the document image processing is subjected to size varying processing (Step #206). If it is judged that the size varying processing has been implemented (YES in Step #206), the controller 226 returns the size of the image data to the original size (Step #207), and terminates the control. If it is judged that the size varying processing has not been implemented (NO in Step #206), the controller 226 terminates the control while skipping Step #207.

On the other hand, if it is judged that image data to be processed is other than character/figure image data (NO in Step #202), the controller 226 implements ordinary image processing such as gradation expanding/correction with respect to the image data other than character/figure image data (Step #208), and terminates the control.

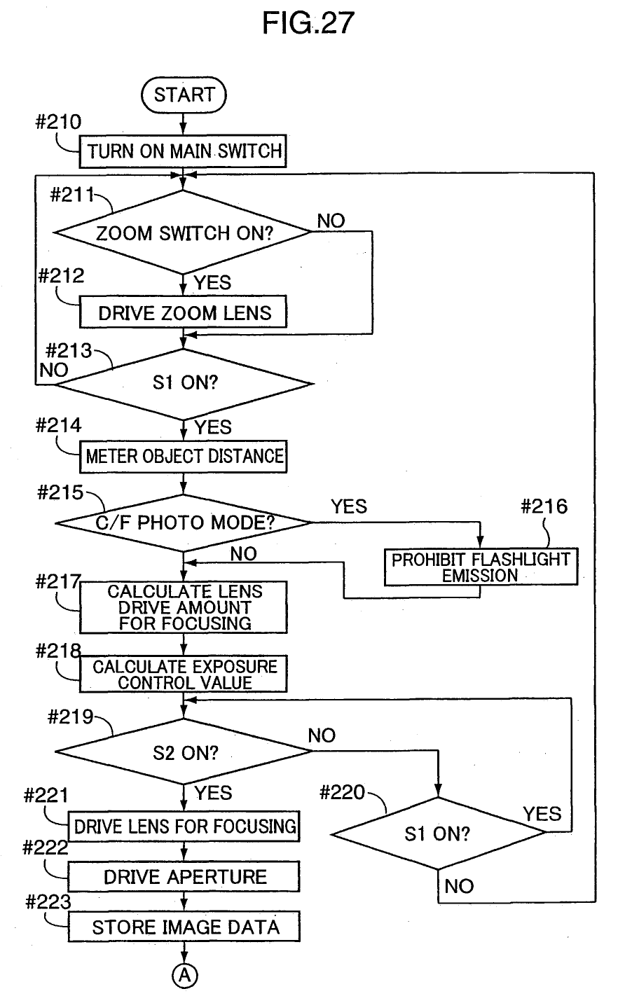

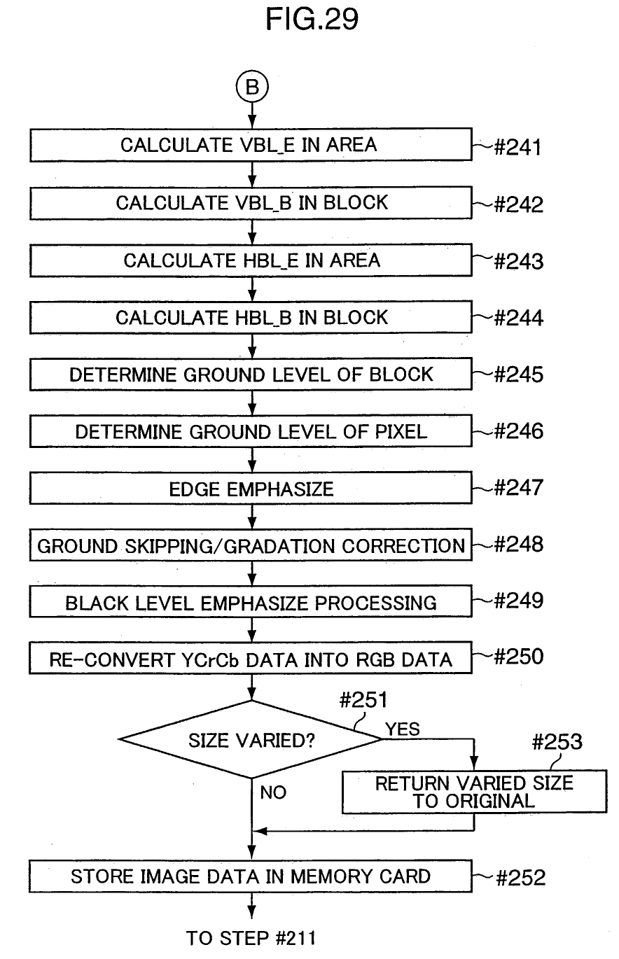

Now, the operation of the digital camera 200 provided with the image processing device in accordance with the second embodiment is described in detail. FIGS. 27 through 30 are a set of flowcharts showing the operation of the digital camera 200 provided with the image processing device in accordance with the second embodiment.

(Image Sensing Operation)

Since the photographing operation of the digital camera 200 which is shown in FIG. 27 is substantially the same as that of the digital camera 100 which has been described referring to FIG. 6, description thereof is omitted herein. Specifically, the operations in Steps #210 through #223 in FIG. 27 are identical to those in Steps #10 through #23 in FIG. 6, respectively.

(Image Processing Operation)

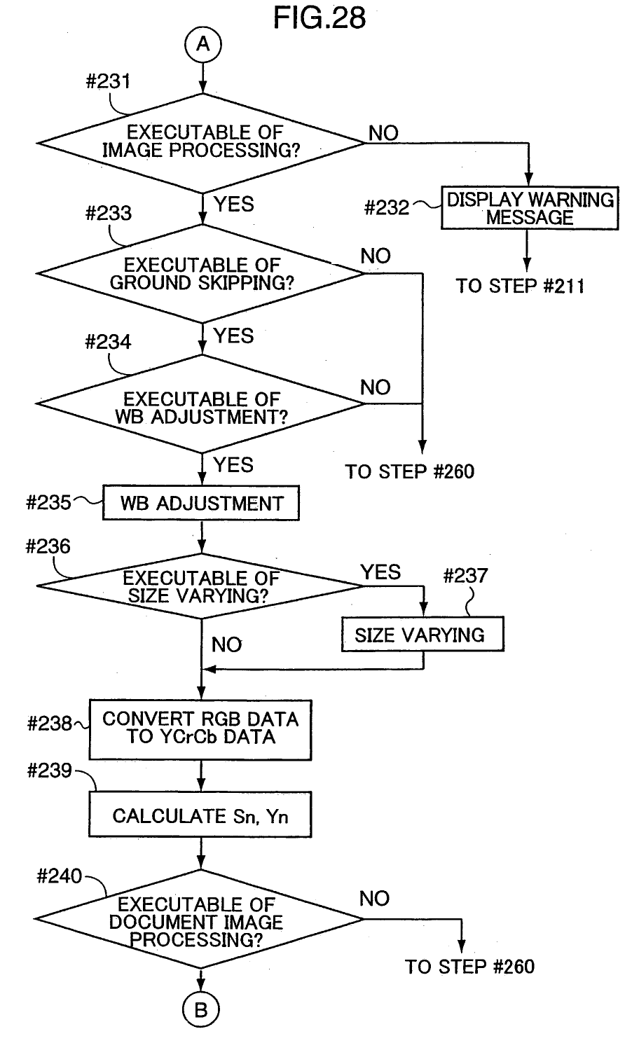

Referring to FIG. 28, the controller 226 implements respective operations in Steps #231 through #235. Since the respective operations in Steps #231 through #235 in the second embodiment shown in FIG. 28 are identical to those in Steps #31 through #35 in the first embodiment which have been described referring to FIG. 7, description on the respective operations in Steps #231 through #235 is omitted herein.

After implementing Step #235, the controller 226 judges whether there is generated a fractional portion after dividing the image data into a number of reference blocks with use of the image size judging section 241 by, for example, dividing the number of pixels corresponding to image data 60 in horizontal and vertical directions by the number of pixels corresponding to a corresponding side of a square block (Step #236). By implementing this operation, it is judged whether size varying processing is necessary with respect to the image data 60. In this embodiment, the reference block is a square block in the aspect of feasibility in matching computation on the number of blocks in horizontal and vertical directions of image data with each other, which will be described later. Alternatively, this invention is applicable to a case where a reference block is a rectangular block having a shorter side and a longer side. Setting a square block as a reference block is advantageous in eliminating a likelihood that directionality may affect results of computation on the number of blocks in horizontal and vertical directions of image data if an image within the block(s) has directionality. The size of a square block is empirically determined by appropriately detecting the ground level of the square block in accordance with a statistical processing with use of a histogram, considering the number of pixels of the image sensing elements of the image sensing section 20 and the size of the image data to be processed. In this embodiment, each side of the square block has 128 pixels.

If it is judged that size varying processing is not necessary (NO in Step #236), the controller 226 proceeds to Step #238. On the other hand, if it is judged that a fractional portion is generated, namely, size varying processing is required (YES in Step #236), the controller 226 implements size varying processing with use of the image size varying section 242 in such a manner that the number of pixels of image data after the size varying processing both in horizontal and vertical directions equals to an integral multiple of the number of pixels corresponding to a corresponding side of square block, and stores information that size varying processing has been implemented into a storage region corresponding to a predetermined address of the storage section 225 (Step #237).

For instance, if the image data 60 has a size corresponding to 1,960 pixels×1,440 pixels, size magnification is implemented such that the number of pixels of the image data 60 in horizontal direction equals to an integral multiple (≧16) of 128 pixels and the number of pixels thereof in vertical direction equals to an integral multiple (≧12) of 128 pixels. Thus, the image data after the size magnification is dividable into a certain number of square blocks without generating a fractional portion.

It is preferable that image data after size varying processing may have a possible minimal size in view of shortening computation time and suppressing image deterioration by minimizing the number of data to be processed. In view of this, in the above case, it is preferable that image data after size varying processing may have 2,048 pixels×1,536 pixels. Thus, the controller 226 generates image data corresponding to 2,048 pixels×1,536 pixels by magnifying the image data 60 by 2,048/1,960 in horizontal direction and by 1,536/1,440 in vertical direction, respectively. For instance, image data corresponding to one pixel is magnified to image data corresponding to (2,048/1,960)×(1,536/1,440) pixels, wherein 2,048 is 16 times of 128, and 1,536 is 12 times of 128.

Alternatively, the controller 126 may reduce the size of image data 60 in such a manner that the number of pixels thereof both in horizontal and vertical directions equals to an integral multiple of the number of pixels corresponding to a corresponding side of a square block.

After implementing size varying processing in Step #237, the controller 226 implements respective operations in Steps #238 through #245. The respective operations in Steps #238 through #245 are identical to those in Steps #38 through #45 in the first embodiment except that whereas the operation in Step #39 is implemented with respect to the first-zone image data 61 or image data 60 itself, the operation in Step #239 is implemented with respect to image data after size varying processing or image data 60 itself and that whereas the mathematical expression 9 is used in the first embodiment, the mathematical expression 9′ is used in the second embodiment. Therefore, description on the respective operations in Steps #238 through #245 is omitted herein.

frequency>384 Ex. 9′

The expression 9′ is a formula for determining the range of the frequency in a class or classes which is or are supposed to correspond to a ground level. Since the ground level is obtained in terms of a class having a maximal frequency, it is necessary that the maximal frequency exceeds other frequencies in the case where the frequencies are uniformly distributed. In view of this, in this embodiment, a threshold value for determining the maximal frequency based on the assumption that the frequencies are uniformly distributed is calculated as 128×1,536/64/8=384 because an area 65 having 128 pixels×1,536 pixels is sampled out every 8 pixels both in horizontal and vertical directions, and 256 gradations are converted into 64 gradations.

By implementing Steps #241 through #245, image data after size varying processing or image data itself has been divided into a number of square blocks, and the ground levels BL_B with respect to the square blocks were calculated block by block. Then, the controller 226 determines the ground level of each pixel based on the calculated ground level BL_B with use of the ground level determining section 243 (Step #246), implements edge emphasizing processing with use of the edge emphasizing section 248 (Step #247), ground skipping/gradation correction with use of the ground skipping/gradation correcting section 244 (Step #248), black level highlight processing with use of the black level emphasizing section 249 (Step #249), and then re-converts brightness data (Y data) and color-difference data (Cr data, Cb data) into RGB data with use of the RGB/YCrCb converting section 247 (Step #250). Since the respective operations in Steps #246 through #250 are identical to those in Steps #48 through #52 in the first embodiment, description of the respective operations in Steps #246 through #250 is omitted herein.

After implementing Step #250, the controller 226 judges whether the image data is image data whose size has been varied (Step #251). If it is judged that size varying processing has not been implemented (NO in Step #251), the controller 226 stores the image data in the memory card 13 with use of the card controlling section 24 (Step #252), and the control in the controller 226 is returned to Step #211. On the other hand, if it is judged that the size varying processing has been implemented (YES in Step #251), the controller 226 varies (returns) the size of the image data 60 into the original size with use of the image size varying section 242 (Step #253), and stores the image data in the memory card 13 (Step #252), and the control in the controller 226 is returned to Step #211.

As mentioned above, the digital camera 200 in accordance with the second embodiment varies the size of a sensed image in such a manner that image data is dividable into a number of square blocks without generating a fractional portion. This arrangement is advantageous in facilitating image processing, namely, in raising the contrast of image data corresponding to information such as characters relative to a white portion such as a whiteboard to reproduce the information clearly in case of reproducing the information of an arbitrary size and in suppressing illumination distribution non-uniformity to provide viewers with easily viewable information. With this arrangement, the digital camera 200 can comply with a demand of reproducing character image data with image quality of high information legibility rather than descriptiveness.

Further, since the digital camera 200 in accordance with the second embodiment is so configured as to vary (return) the size of image data into the original size after implementing a series of image processing, image data having the original size is retainable.

(Image Processing Concerning Image in Which Ground Skipping/Gradation Correction is Un-Executable, WB Fine Adjustment is Un-Executable, Image Having Dark Ground Portion, Image Having Ground Portion of Dark Color, or Photographic Image)

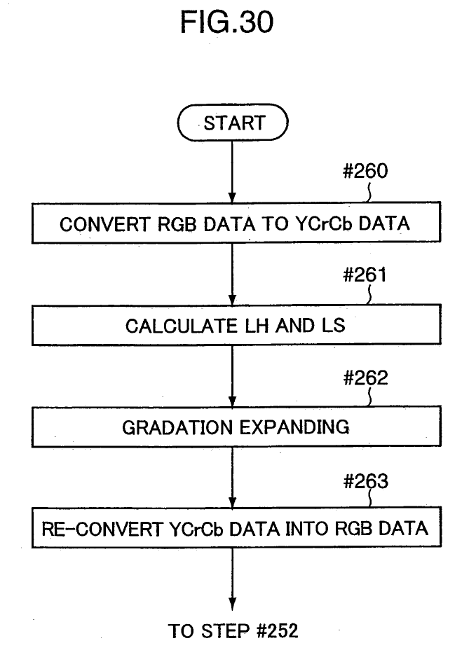

Operations of the digital camera 200 in case of processing an image in which ground skipping/gradation correction is un-executable, an image in which WB fine adjustment is un-executable, an image having a dark ground portion, an image having a ground portion of a dark color, or a photographic image, which are shown in FIG. 30 are identical to those in the first embodiment. Accordingly, description on these operations in the second embodiment is omitted herein. Specifically, the operations in Steps #250 through #263 in FIG. 30 are identical to those in Steps #60 through #63 in FIG. 9, respectively.

As mentioned above, in the digital camera 200 in accordance with the second embodiment, judgment is automatically made as to whether the image has a size executable of ground skipping/gradation correction in Step #233, whether the image has a size executable of WB fine adjustment in Step #234, and whether the image has a size executable of document image processing in Step #240 in the case where the image is an image in which ground skipping/gradation correction is un-executable, an image in which WB fine adjustment is un-executable, and an image in which document image processing is un-executable such as an image having a dark ground portion, an image having a ground portion of a dark color, or a photographic image, and appropriate gradation expanding correction is implemented depending on the condition. With this arrangement, even if an image to be processed is any one of the aforementioned images, the digital camera 200 in accordance with the second embodiment is capable of reproducing images of excellent descriptiveness by converting a sensed image into image data having a suitable number of gradations by efficiently utilizing the range of gradations (in this embodiment, 256 gradations).

Now, a still another embodiment of this invention is described.

(Third Embodiment)

The digital camera 100 in accordance with the first embodiment implements an image processing by implementing zone-dividing with respect to a sensed image in such a manner that image data is dividable into a number of square blocks without generating a fractional portion. A digital camera in accordance with the third embodiment of this invention implements an image processing by varying the size of a sensed image in such a manner that image data is dividable into a plurality of square blocks without generating a fractional portion.

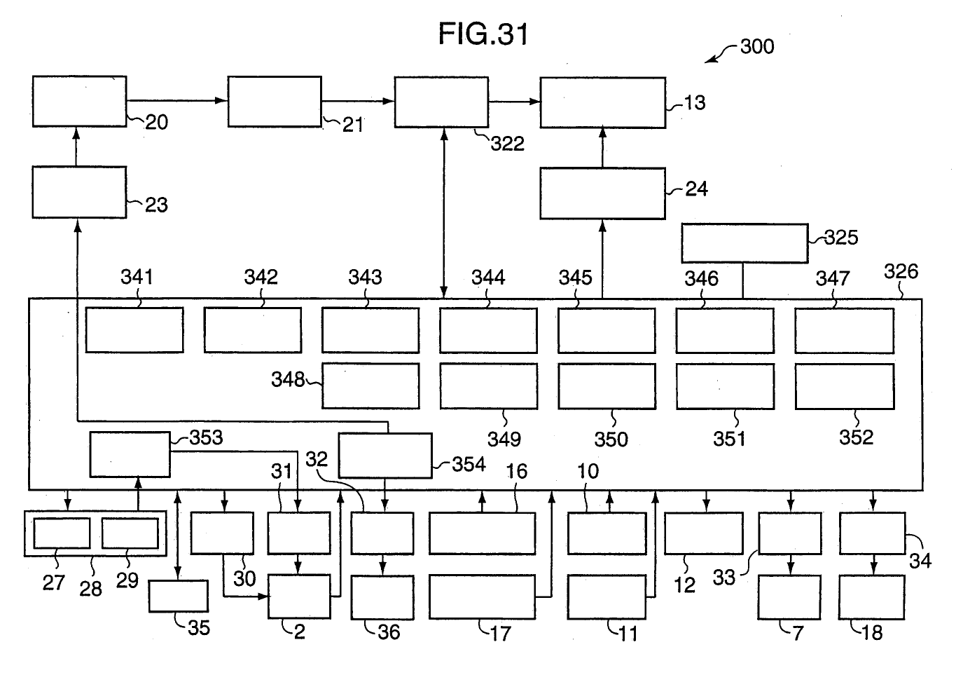

Since an external appearance of the digital camera 300 in the third embodiment is substantially the same as that of the digital camera 100 in the first embodiment, description on elements in the third embodiment which are identical to those in the first embodiment is omitted herein. FIG. 31 is a block diagram of the digital camera 300. The digital camera 300 basically comprises, as shown in FIG. 31, an image sensing section 20, an A/D converting section 21, an image memory 322, a memory card 13, an image sensing driving section 23, a card controlling section 24, a storage section 325, a controller 326, a distance metering section 28, a zoom driving section 30, a lens driving section 31, an aperture driving section 32, a photographing mode setting switch 16, a shutter button 10, a photographing/reproducing switch 12, a light emission controlling section 33, an LCD driving section 34, a light metering section 35, a taking lens 2, an aperture 36, an image resolution setting switch 17, a zoom switch 11, a flashlight section 7, and an LCD section 18.

The controller 326 comprises an image size judging section 341, an image size varying section 342, a block ground level determining section 343, a block ground level allocating section 344, a pixel ground level determining section 345, a ground skipping/gradation correcting section 346, an LH/LS calculating section 347, a WB fine adjustment section 348, an RGB/YCrCb converting section 349, an edge emphasizing section 350, a black level emphasizing section 351, a gradation expanding/correcting section 352, an AF control value calculating section 353, and an exposure value calculating section 354. The image memory 322, the card controlling section 24, the storage section 325, and the controller 326 constitute an image processing device in accordance with the third embodiment of this invention.

Elements of the digital camera 300 having different functions from those of the digital camera 100 in the first embodiment are described as follows.

The image memory 322 is a memory which is connected with the controller 326 and temporarily stores image data to implement an image processing. The image memory 322 implements a predetermined processing with respect to image data, which will be described later, and outputs the processed image data to the memory card 13. The image memory 322 includes e.g. an RAM, and has a sufficient storage capacity of storing original image data corresponding to a sensed image before size varying processing and image data corresponding to the sensed image after size varying processing in view of e.g. integral processing.

The storage section 325 is a memory which is connected with the controller 326 and stores various data such as a variety of programs necessary for operating the digital camera 300 and data to be processed while the program is running. The storage section 325 is comprised of e.g. an RAM and an ROM.

The controller 326 includes a microprocessor, and centrally controls photographing and image processing operations of the digital camera 300 by the elements 341 through 354. The image size judging section 341 detects the size of image data generated by sensing an object image, and judges whether the detected size is a size executable of image processing, a size executable of ground skipping/gradation correction, a size executable of WB fine adjustment, and a size necessary of size varying processing. The image size varying section 342 magnifies or reduces image data into a certain size. The block ground level determining section 343 calculates the ground level of an area of image data in accordance with a statistical processing, and then calculates the ground level of a block. The block ground level allocating section 344 allocates the ground level of each block based on a correspondence between the block of the original image data and the block of image data after size varying processing. The pixel ground level determining section 345 calculates the ground level of a pixel based on the ground level of the block allocated by the block ground level allocating section 344. The ground skipping/gradation correcting section 346, the LH/LS calculating section 347, the WB fine adjustment section 348, the RGB/YCrCb converting section 349, the edge emphasizing section 350, the black level emphasizing section 351, the gradation expanding/correcting section 352, the AF control value calculating section 353, and the exposure control value calculating section 354 respectively correspond to the ground skipping/gradation correcting section 146, the LH/LS calculating section 147, the WB fine adjustment section 148, the RGB/YCrCb converting section 149, the edge emphasizing section 150, the black level emphasizing section 151, the gradation expanding/correcting section 152, the AF control value calculating section 153, and the exposure control value calculating section 154 in the first embodiment. Accordingly, description on the elements 346 through 354 is omitted,herein.

(Operation of the Third Embodiment)

Now, operation of the digital camera 300 provided with the image processing device in accordance with the third embodiment is described roughly and then in detail. First, operation of the digital camera 300 in the third embodiment is described roughly.

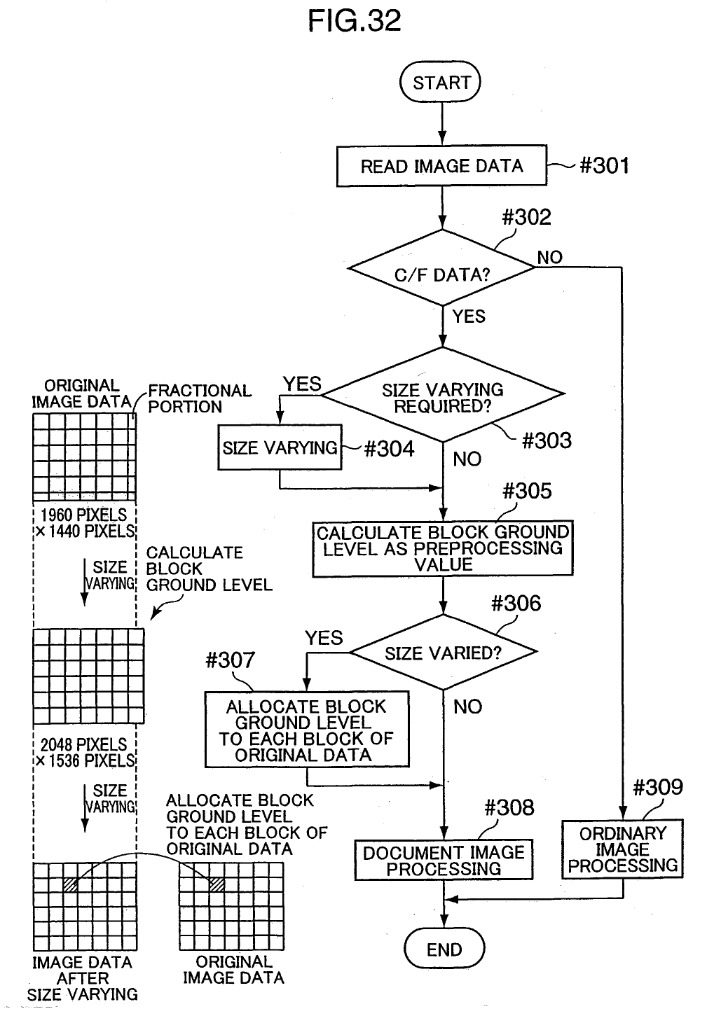

FIG. 32 is a flowchart showing a schematic operation of the image processing in the third embodiment.

Referring to FIG. 32, first, image data to be processed is read (Step #301). As with the case of the first embodiment, various image data can be read in the third embodiment.

Next, the controller 326 judges whether the size of the image data and the image data itself meet the requirements concerning document image processing. If it is judged that the image data is character/figure image data or the like that has been obtained by sensing information such as characters written on a whiteboard or the like (YES in Step #302), the controller 326 proceeds to Step #303. On the other hand, if it is judged that the image data is other than character/figure image data (NO in Step #302), the controller 326 proceeds to Step #309 where processing with respect to image data other than character/figure image data is implemented.

In Step #303, the controller 326 judges whether it is necessary to vary the size of the image data. If it is judged that the image data does not have a size corresponding to an integral multiple of the size of a reference block (YES in Step #303), the controller 326 proceeds to Step #304 and then to Step #305. On the other hand, if it is judged that the image data has a size corresponding to an integral multiple of the size of the reference block (NO in Step #303), the controller 326 proceeds to Step #305 while skipping Step #304. For instance, in the case where the image data has a size corresponding to 1,960 pixels×1,440 pixels, and the reference block is a square block corresponding to 128 pixels×128 pixels, there is generated a fractional portion corresponding to 40 pixels in horizontal direction and 32 pixels in vertical direction. In such a case, size varying processing is necessary.

The size varying processing in Step #304 is such that the size of the image data is magnified or reduced such that the number of pixels of the image data after magnification/reduction both in horizontal and vertical directions equals to an integral multiple of the number of pixels corresponding to a corresponding side of a reference block. For instance, image data having 2,048 pixels×1,536 pixels is generated by magnifying the size of the image data by 2,048/1,960 in horizontal direction and by magnifying the size of the image data by 1,536/1,440 in vertical direction.

In Step #305, the controller 326 calculates the ground level, block by block, as a preprocessing value necessary for implementing ground skipping/gradation correction. Ground skipping/gradation correction is such that a brightness level exceeding a predetermined threshold value is converted to a possible maximal brightness level with respect to each pixel to reproduce character information clearly. Since the predetermined threshold value is calculated based on the ground level with respect to each block, it is necessary to calculate the ground level with respect to each block prior to ground skipping/gradation correction.

Next, the controller 326 judges whether size varying processing has been implemented with respect to the image data whose ground level in the block is known as a preprocessing value (Step #306). If it is judged that size varying processing has not been implemented (NO in Step #306), the controller 326 proceeds to Step #308. On the other hand if it is judged that size varying processing has been implemented (YES in Step #306), the controller 326 returns the size of the image data to the size of the original image data by size re-varying processing, and allocates the ground level in each block which has been calculated based on the image data whose size has been varied in Step #305 to each block of the original data having the original size (Step #307).

Then, in Step #308, the controller 326 calculates a predetermined threshold value to be used in ground skipping/gradation correction pixel by pixel based on the ground level in each block, and implements a series of document image processing such as ground skipping/gradation correcting processing, edge emphasizing processing, and black level highlight processing for converting a brightness level not exceeding a predetermined threshold value to a black level with respect to the original image data so as to reproduce character information clearly. In this embodiment, the ground level in each block is computable based on size varying processing in Step #304 and ground level allocating processing in Step #307 even if the original data does not have a size both in horizontal and vertical directions equal to an integral multiple of the number of pixels corresponding to a corresponding side of a reference block. Thus, ground skipping/gradation correction can be implemented with respect to image data having an arbitrary size. Further, since ground skipping/gradation correction is implemented with respect to original image data in place of image data after size varying processing, this arrangement can suppress deterioration of image reproducibility.

On the other hand, if it is judged that the read image data is other than character/figure image data (NO in Step #302), the controller 326 implements ordinary image processing such as gradation expanding correction with respect to the image data other than character/figure image data (Step #309), and terminates the control.

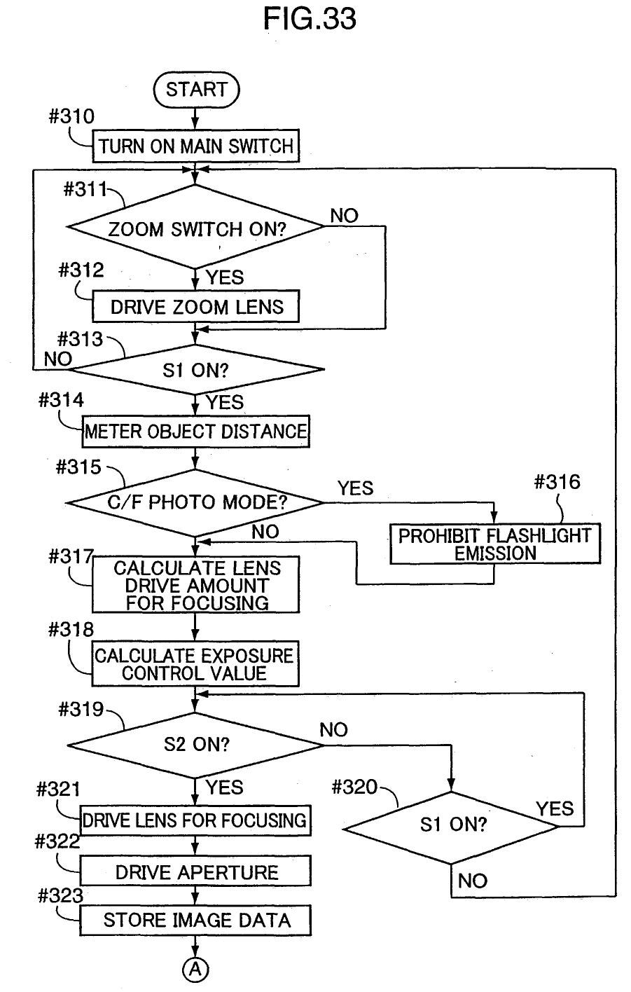

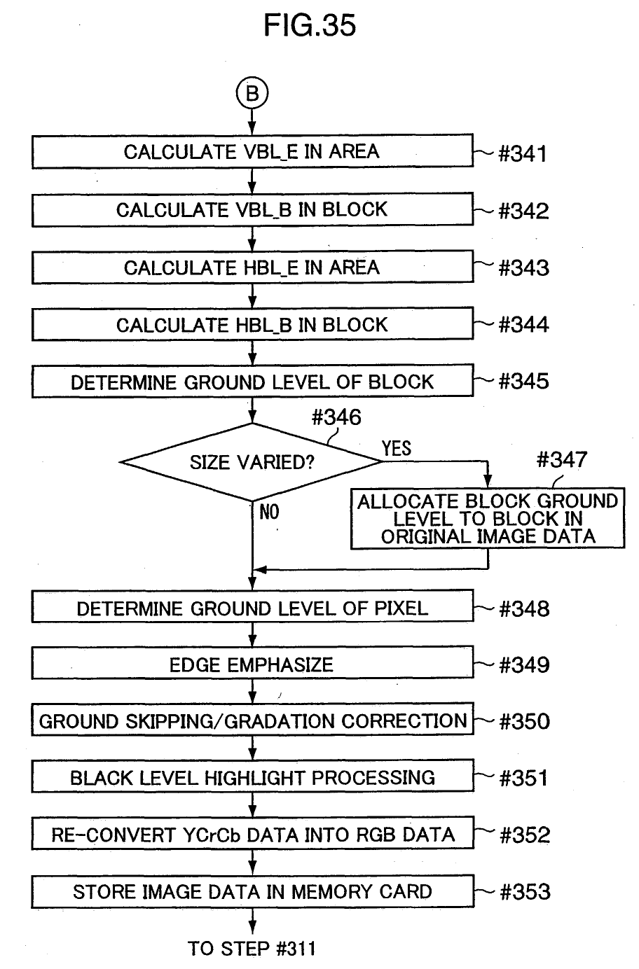

Now, the operation of the digital camera 300 provided with the image processing device in accordance with the third embodiment is described in detail. FIGS. 33 through 36 are a set of flowcharts showing the operation of the digital camera 300 provided with the image processing device in accordance with the third embodiment.

(Image Sensing Operation)

Since the photographing operation of the digital camera 300 which is shown in FIG. 33 is substantially the same as that of the digital camera 100 which has been described referring to FIG. 6, description thereof is omitted herein. Specifically, the operations in Steps #310 through #323 in FIG. 33 are identical to those in Steps #10 through #23 in FIG. 6, respectively.

(Image Processing Operation)

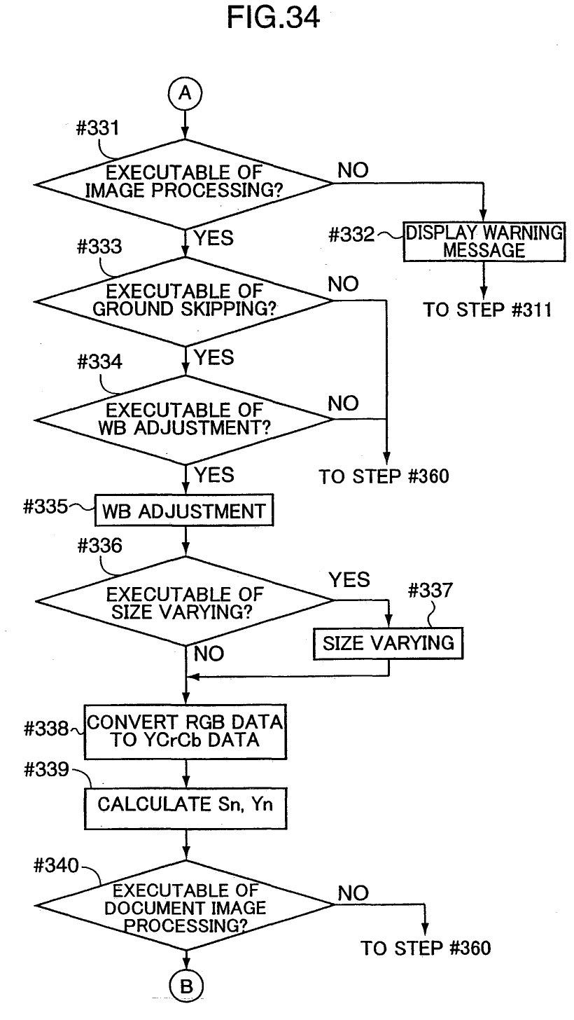

Referring to FIG. 34, the controller 326 implements respective operations in Steps #331 through #335. Since the respective operations in Steps #331 through #335 in the third embodiment shown in FIG. 34 are identical to those in Steps #31 through #35 in the first embodiment which have been described referring to FIG. 7, description on the respective operations in Steps #331 through #335 is omitted herein.

After implementing Step #335, the controller 326 judges whether there is generated a fractional portion after dividing the image data into a number of reference blocks with use of the image size judging section 341 by, for example, dividing the number of pixels corresponding to image data 60 in horizontal and vertical directions by the number of pixels corresponding to a corresponding side of a square block (Step #336). By implementing this operation, it is judged whether size varying processing is necessary with respect to the image data 60. In this embodiment, the reference block is a square block in the aspect of feasibility in matching computation on the number of blocks in horizontal and vertical directions of image data with each other, which will be described later. Alternatively, this invention is applicable to a case where a reference block is a rectangular block having a shorter side and a longer side. Setting a square block as a reference block is advantageous in eliminating a likelihood that directionality may affect results of computation on the number of blocks in horizontal and vertical directions of image data if an image within the block(s) has directionality. The size of a square block is empirically determined by appropriately detecting the ground level of the square block in accordance with a statistical processing with use of a histogram, considering the number of pixels of the image sensing elements of the image sensing section 20 and the size of the image data to be processed. In this embodiment, each side of the square block has 128 pixels.

If it is judged that size varying processing is not necessary (NO in Step #336), the controller 326 proceeds to Step #338. On the other hand, if it is judged that a fractional portion is generated, namely, size varying processing is required (YES in Step #336), the controller 326 implements size varying processing with use of the image size varying section 342 in such a manner that the number of pixels of image data after size varying processing both in horizontal and vertical directions equals to an integral multiple of the number of pixels corresponding to a corresponding side of a square block, and stores information that size varying processing has been implemented into a storage region corresponding to a predetermined address of the storage section 325 (Step #337).

For instance, if the image data 60 has a size corresponding to 1,960 pixels×1,440 pixels, size magnification is implemented such that the number of pixels of the image data 60 in horizontal direction equals to an integral multiple (≧16) of 128 pixels and the number of pixels thereof in vertical direction equals to an integral multiple (≧12) of 128 pixels. Thus, the image data after the size magnification is dividable into a certain number of square blocks without generating a fractional portion.

It is preferable that image data after size varying processing may have a possible minimal size in view of shortening computation time and suppressing image deterioration by minimizing the number of data to be processed. In view of this, in the above case, it is preferable that image data after size varying processing may have 2,048 pixels×1,536 pixels. Thus, the controller 326 generates image data corresponding to 2,048 pixels×1,536 pixels by magnifying the image data 60 by 2,048/1,960 in horizontal direction and by 1,536/1,440 in vertical direction, respectively. For instance, image data corresponding to one pixel is magnified to image data corresponding to (2,048/1,960)×(1,536/1,440) pixels, wherein 2,048 is 16 times of 128, and 1,536 is 12 times of 128.

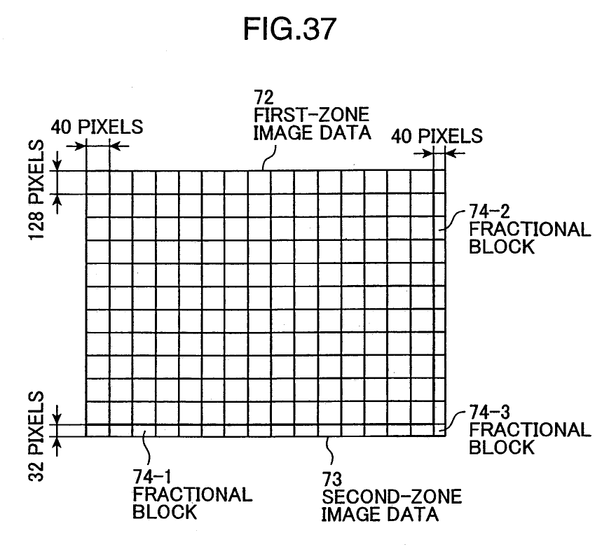

A fractional block is a rectangular block which is defined by vertical and horizontal grid lines defining a reference square block in first-zone image data in the case where original image data is divided into the first-zone image data which is dividable into a certain number of square blocks, and second-zone image data which is a remainder of the original image data obtained by removing the first-zone image data. For instance, referring to FIG. 37, when a first-zone image data 72 occupies an upper left portion of the original image data 60, a second-zone image data 73 occupies an inverted L-shape portion of the original image data 60 extending upward and leftward directions. In this case, there are generated a number of fractional blocks consisting of 15 pieces of fractional blocks 74-1 arrayed in a row (horizontal direction) each having a size corresponding to 128 pixels×32 pixels, 11 pieces of fractional blocks 74-2 arrayed in a column (vertical direction) each having a size corresponding to 40 pixels'128 pixels, and one corner fractional block 74-3 having a size corresponding to 40 pixels×32 pixels.

Alternatively, the controller 326 may reduce the size of original image data in such a manner that the number of pixels thereof both in horizontal and vertical directions equals to an integral multiple of the number of pixels corresponding to a corresponding side of a square block.

After implementing size varying processing in Step #337, the controller 326 implements respective operations in Steps #338 through #345. The respective operations in Steps #338 through #345 are identical to those in Steps #38 through #45 in the first embodiment except that whereas the operation in Step #39 is implemented with respect to the first-zone image data 61 or original image data 60 itself, the operation in Step #339 is implemented with respect to image data after size varying processing or original image data 60 itself and that whereas the mathematical expression 9 is used in the first embodiment, the mathematical expression 9′ is used in the third embodiment. Therefore, description on the respective operations in Steps #338 through #345 is omitted herein.

After implementing Step #345, the controller 326 judges whether the image data is image data whose size has been varied (Step #346). If it is judged that size varying processing has been implemented (YES in Step #346), the controller 326 proceeds to Step #347, and then Step #348. On the other hand, if it is judged that size varying processing has not been implemented (NO in Step #346), the controller 326 proceeds to Step #348 while skipping Step #347.

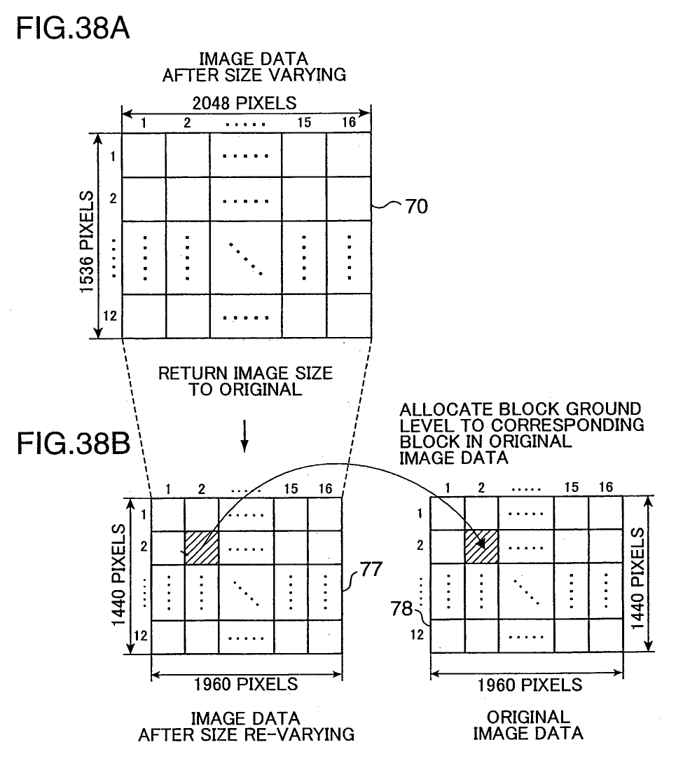

In Step #347, the controller 326 varies again the size of image data 70 which is image data after size varying processing with use of the image size varying section 342, namely, returns the size of the image data 70 to the size of the original image data 60. For instance, in the above example, the image size varying section 342 generates image data 77 having a size corresponding to 1,960 pixels×1,440 pixels, which is image data after size re-varying processing and is shown on left side in FIG. 38B, by magnifying the image data 70 having a size corresponding to 2,048 pixels×1,536 pixels by 1,960/2,048 in horizontal direction and by 1,440/1,536 in vertical direction (namely, size reduction is implemented in this case). As a result of size re-varying processing, a square block of 128 pixels×128 pixels is magnified by 1,960/2,048 in horizontal direction and by 1,440/1,536 in vertical direction.

Subsequently, the controller 326 allocates the ground levels BL_B in respective blocks calculated based on the image data 70 to respective blocks of the original image data 60 based on a correspondence between block of the original image data 60 and block of the image data 77. For instance, in the above example, the block ground level allocating section 344 divides, as shown in FIG. 38B, original image data 78 (or original image data 60) into a number of square blocks in such a manner that the number of square blocks in the original image data 78 equals to the number of square blocks in the image data 77 after size re-varying processing both in horizontal and vertical directions. In this embodiment, the original image data 78 is divided into 16 square blocks and 12 square blocks in horizontal and vertical directions, respectively. Since there is no necessity of implementing statistical processing such as Steps #341 through #344 with respect to the original image data 78, there is no constraint regarding the size of a square block in the original image data 78 as mentioned above. As with the case of the image data 77, the original image data 78 is divided into a number of square blocks. Accordingly, the block at i-th row, j-th column in the original image data 78 corresponds to the block at i-th row, j-th column in the image data 77 after size re-varying processing. Since the block at i-th row, j-th column in the image data 77 is merely subjected to size varying processing, the block at i-th row, j-th column in the image data 77 corresponds to the block at i-th row, j-th column in the image data 70. Therefore, the ground level BL_B in the block at i-th row, j-th column of the original image data 78 corresponds to the ground level BL_B in the block at i-th row, j-th column of the image data 70. In view of this, the block ground level allocating section 344 allocates the ground level BL_B in the block at i-th row, j-th column of the image data 70 to the ground level BL_B in the block at i-th row, j-th column of the original image data 78 based on the correspondence between the ground level BL_B in the block at i-th row, j-th column of the original image data 78 and the ground level BL_B in the block at i-th row, j-th column of the image data 70. The symbols i, j are positive integers in the values obtained by dividing the number of pixels of the original image data 78 in horizontal and vertical directions by the number of pixels on the corresponding side of a reference block, respectively. In the above example, i is an integer from 1 to 12, and j is an integer from 1 to 16.

By implementing the above operations, the ground level BL_B is allocated to each block of the original image data 78. Next, the controller 326 determines the ground level of each pixel based on the calculated ground level BL_B with use of the ground level determining section 343 (Step #348), implements edge emphasizing processing with use of the edge emphasizing section 350 (Step #349), ground skipping/gradation correction with use of the ground skipping/gradation correcting section 346 (Step #350), black level highlight processing with use of the black level emphasizing section 351 (Step #351), re-converts brightness data (Y data) and color-difference data (Cr data, Cb data) into RGB data with use of the RGB/YCrCb converting section 349 (Step #352), stores the processed image data in the memory card 13 with use of the card controlling section 24 or the like (Step #353), and the control in the controller 346 is returned to Step #311. Since the respective operations in Steps #348 through #353 are identical to those in Steps #48 through #53 in the first embodiment, description on the respective operations in Steps #348 through #353 is omitted herein.

As mentioned above, the digital camera 300 in accordance with the third embodiment varies the size of a sensed image in such a manner that image data is dividable into a number of square blocks without generating a fractional portion. This arrangement is advantageous in facilitating image processing, namely, in raising the contrast of image data corresponding to information such as characters relative to a white portion such as a whiteboard to reproduce the information clearly in case of reproducing the information of an arbitrary size and in suppressing illumination distribution non-uniformity to provide viewers with easily viewable information. With this arrangement, the digital camera 300 can comply with a demand of reproducing character image data with image quality of high information legibility rather than descriptiveness.

Further, since the digital camera 300 in accordance with the third embodiment is so configured as to implement image processing with respect to original image data, this arrangement can suppress deterioration of image reproducibility.

(Image Processing Concerning Image in Which Ground Skipping/Gradation Correction is Un-Executable, WB Fine Adjustment is Un-Executable, Image Having Dark Ground Portion, Image having Ground Portion of Dark Color, or Photographic Image)

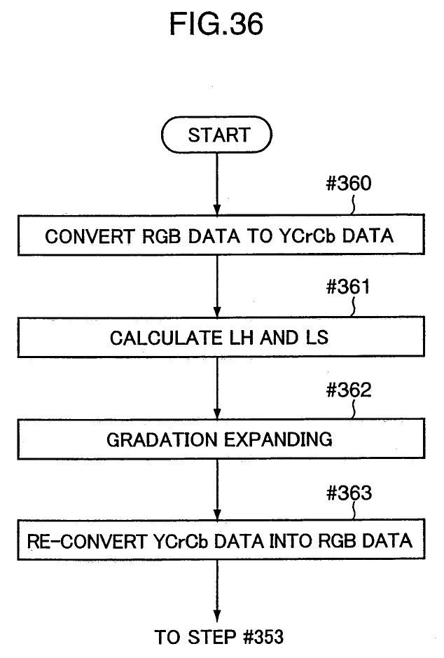

Operations of the digital camera 300 in case of processing an image in which ground skipping/gradation correction is un-executable, an image in which WB fine adjustment is un-executable, an image having a dark ground portion, an image having a ground portion of a dark color, or a photographic image, which are shown in FIG. 36 are identical to those in the first embodiment, which has been described referring to FIG. 9. Accordingly, description on these operations in the third embodiment is omitted herein. Specifically, the operations in Steps #360 through #363 in FIG. 36 are identical to those in Steps #60 through #63 in FIG. 9, respectively.

As mentioned above, in the digital camera 300 in accordance with the third embodiment, judgment is automatically made as to whether the image has a size executable of ground skipping/gradation correction in Step #333, whether the image has a size executable of WB fine adjustment in Step #334, and whether the image has a size executable of document image processing in Step #340 in the case where the image is an image in which ground skipping/gradation correction is un-executable, an image in which WB fine adjustment is un-executable, and an image in which document image processing is un-executable such as an image having a dark ground portion, an image having a ground portion of a dark color, or a photographic image, and appropriate gradation expanding correction is implemented depending on the condition. With this arrangement, even if an image to be processed is any one of the aforementioned images, the digital camera 300 in accordance with the third embodiment is capable of reproducing images of excellent descriptiveness by converting a sensed image into image data having a suitable number of gradations by efficiently utilizing the range of gradations (in this embodiment, 256 gradations).

In the first to third embodiments, image processing is implemented with use of Y data by converting RGB image data to YCrCb image data. Alternatively, as disclosed in Japanese Unexamined Patent Publication No. 10-210287, it may be possible to implement image processing by a series of operations of setting a correction characteristic regarding illumination distribution non-uniformity based on G data without converting RGB image data to YCrCb image data and setting a correction characteristic regarding illumination distribution non-uniformity based on R and B data.

In the first to third embodiments, document image processing is implemented with respect to image data photographed by the digital camera on real-time basis. Alternatively, the inventive image processing device may be so configured as to implement document image processing with respect to image data obtained by sensing a document image or image data obtained by reading a photographic image of a document image taken by a still camera with use of an image reader such as a scanner. An image reader for use in the first embodiment may comprise, for instance, the image memory 22, the card controlling section 24, the storage section 25, an input section incorporated with a keyboard and a mouse for allowing a user to enter a command, an output section incorporated with an LCD and a CRT for displaying an image and the entered command thereon, and the controller 126 for controlling the image memory 22, the card controlling section 24, the storage section 25, the input and output sections, as well as implementing the operations in Steps #31 through #53 in FIGS. 7 and 8 and Steps #60 through #63 in FIG. 9. Alternatively, a computer may be applicable as the image reader for use in the first embodiment by installing a computer program for implementing the operations in Steps #31 through #53 in FIGS. 7 and 8 and Steps #60 through #63 in FIG. 9 from a computer-readable storage medium recording such a computer program. Such a computer may, for instance, comprise a storage section which stores a program and various data to be processed while the program is running, an input section (e.g. keyboard and mouse) for allowing a user to enter a command and necessary data, an output section (e.g. display and printer) for outputting image data and other various data to an external device, and a processor which controls the storage section, the input section, and the output section, and implements various computations such as execution of the program. Alternatively, the computer may be incorporated with an auxiliary storage section, an external storage device, or a communications interface according to needs. The storage medium may be, for instance, a flexible disk, a CD-ROM, a CD-R, a DVD, and a memory card. Image data for document image processing is temporarily stored in the storage medium such as a memory card prior to output to the image processing device.

As this invention may be embodied in several forms without departing from the spirit of essential characteristics thereof, the present embodiment is therefore illustrative an not restrictive, since the scope of the invention is defined by the appended claims rather than by the description preceding them, and all changes that fall within metes and bounds of the claims, or equivalence of such metes and bounds are therefore intended to embraced by the claims.

What is claimed is:

1. An image processing device comprising:
an image size detecting section which detects a size of original image data;
a judging section which judges, based on a detection result of the image size detecting section, whether the size of the original image data in at least one of a horizontal direction and a vertical direction equals to an integral multiple of a size of a corresponding side of a reference block;
a processing value setting section which sets a processing value used for implementing an image processing with respect to a region of the original image data other than a region defined by the integral multiple of the size of the reference block if the judging section judges that the size of the original image data does not equal to the integral multiple of the size of the reference block; and
an image processing section which implements the image processing based on the processing value set by the processing value setting section.

2. The image processing device according to claim 1, wherein the processing value set by the processing value setting section is determined based on a processing value set with respect to the region defined by the integral multiple of the size of the reference block.

3. The image processing device according to claim 1, wherein the processing value set by the processing value setting section is determined based on image data obtained by converting the size of the original image data to a size equal to the integral multiple of the size of the reference block.

4. The image processing device according to claim 3, further comprising a re-converting section which returns the converted image size to the size of the original image data by size conversion.

5. The image processing device according to claim 3, wherein the image processing section implemented an image processing with respect to the original image data before the size conversion with use of the processing value set by the processing value setting section.

6. An image processing device comprising:
an image size detecting section which detects a size of original image data;
a judging section which judges, based on a detection result of the image size detecting section, whether the size of the original image data in at least one of a horizontal direction and a vertical direction equals to an integral multiple of a size of a corresponding side of a reference block;
a processing value setting section which sets a processing value used for implementing an image processing with respect to a region of the original image data other than a region defined by the integral multiple of the size of the reference block if the judging section judges that the size of the original image data does not equal to the integral multiple of the size of the reference block,
the processing value setting section including:
a zone dividing section which divides the original image data into first-zone image data and second-zone image data:
a first calculating section which calculates, reference block by block, a first preprocessing value used for implementing an image processing with respect to the first-zone image data; and
a second calculating section which calculates, fractional block by block, a second preprocessing value used for implementing an image processing with respect to the second-zone image data based on the first preprocessing value, and wherein the processing value set by the processing value setting section is determined based on the first preprocessing value and the second preprocessing value, the first-zone image data having a size both in the horizontal direction and the vertical direction equal to the integral multiple of the size of the corresponding side of the reference block, the second-zone image data being a remainder of the image data obtained by removing the first-zone image data from the original image data; and
an image processing section which implements the image processing based on the processing value set by the processing value setting section.

7. The image processing device according to claim 6, wherein the image processing is a shading correction of adjusting a gradation of the image data.

8. The image processing device according to claim 7, wherein the second preprocessing value is a ground level of the image data corresponding to a brightness level on a ground portion of the image data, and the shading correction includes a ground skipping/gradation correction in which a threshold value is set pixel by pixel based on the ground level, and a brightness level of the pixel is replaced with a possible maximal brightness level pixel by pixel if it is judged that the brightness level of the pixel exceeds the threshold value.

9. The image processing device according to claim 6, wherein the reference block is a square.

10. The image processing device according to claim 6, wherein the second calculating section calculates the second preprocessing value in accordance with a linear extrapolation based on the first preprocessing value calculated by the first calculating section to implement the image processing with respect to the second-zone image data, fractional block by block.

11. The image processing device according to claim 6, wherein the first-zone image data is arranged at a substantially central part of the original image data to arrange the second-zone image data uniformly along a peripheral portion of the original image data.

12. The image processing device according to claim 6, wherein the second preprocessing value is obtained by a vertical preprocessing value which is defined in the vertical direction of the image data and a horizontal preprocessing value which is defined in the horizontal direction of the image data.

13. An image processing device comprising:
image size detecting means for detecting a size of original image data;
image size converting means for converting, based on a detection result of the image size detecting means, the size of the original image data both in a horizontal direction and a vertical direction to a size equal to an integral multiple of a size of a corresponding side of a reference block if the image size detecting means judges that the size of the original image data in at least one of the horizontal direction and the vertical direction does not equal to the integral multiple of the size of the corresponding side of the reference block;
image processing means for implementing an image processing with respect to the image data having the converted size; and
image size re-converting means for returning the size of the image data having the converted size to the size of the original image data by size re-conversion.

14. The image processing device according to claim 13, wherein the image processing is a shading correction of adjusting a gradation of the image data.

15. The image processing device according to claim 14, wherein the shading correction includes a ground skipping/gradation correction in which the original image data is divided based on the reference block to calculate a ground level, reference block by block, a threshold value is set pixel by pixel based on the calculated ground level in the reference block, and a brightness level of the pixel is replaced with a possible maximal brightness level pixel by pixel if it is judged that the brightness level of the pixel exceeds the threshold value.

16. The image processing device according to claim 15, wherein the reference block is a square.

17. An image processing device comprising:
an image size detecting section which detects a size of original image data;
a judging section which judges, based on a detection result of the image size detecting section, whether the size of the original image data in at least one of a horizontal direction and a vertical direction equals to an integral multiple of a size of a corresponding side of a reference block;
a processing value setting section which sets a processing value used for implementing an image processing with respect to a region of the original image data other than a region defined by the integral multiple of the size of the reference block if the judging section judges that the size of the original image data does not equal to the integral multiple of the size of the reference,block,
the processing value setting section including:
image size converting means for converting the size of the original image data both in the horizontal direction and the vertical direction to a size equal to the integral multiple of the size of the corresponding side of the reference block if the judging section judges that the size of the original image data in the horizontal direction and the vertical direction does not equal to the integral multiple of the size of the corresponding side of the reference block; and
calculating means for calculating a first preprocessing value used for implementing the image processing with respect to the image data having the converted size, reference block by block, and wherein the processing value set by the processing value setting section is determined based on the first preprocessing value calculated by the calculating means; and
an image processing section which implements the image processing based on the processing value set by the processing value setting section.

18. The image processing device according to claim 17, wherein the image processing is a shading correction of adjusting a gradation of the image data.

19. The image processing device according to claim 18, wherein the preprocessing value is a ground level of the image data, and the shading correction includes a ground skipping/gradation correction in which a threshold value is set pixel by pixel based on the ground level of the image data, and a brightness level of the pixel is replaced with a possible maximal brightness level pixel by pixel if it is judged that the brightness level of the pixel exceeds the threshold value.

20. The image processing device according to claim 17, wherein the reference block is a square.
